(19) United States
(12) Patent Application Publication
(10) Pub. No.: US 2008/0092758 A1
(43) Pub. Date: Apr. 24, 2008

(54) STOP POSITION CONTROL METHOD AND APPARATUS OF ROTARY STENCIL PRINTING PRESS

(76) Inventors: Hiromitsu Numauchi, Tsukuba-shi (JP); Isao Komuro, Noda-shi (JP); Akehiro Kusaka, Noda-shi (JP)

Correspondence Address: BIRCH STEWART KOLASCH & BIRCH, PO BOX 747, FALLS CHURCH, VA, 22040-0747, US

(21) Appl. No.: 11/875,519

(22) Filed: Oct. 19, 2007

(30) Foreign Application Priority Data
Oct. 20, 2006 (JP) 2006-287029
Mar. 29, 2007 (JP) 2007-86621

(51) Int. Cl. B41L 13/00

(52) U.S. Cl. 101/116; 101/129

(57) ABSTRACT

In a rotary screen device in which ink is transferred through holes of a screen, with a rotary screen cylinder provided with the screen being rotated, to carry out printing, the rotary screen cylinder is stopped, in accordance with a stop signal, at a position at which a pattern-free portion (a hole-free portion) of the screen comes to a lowermost position. Since the rotation of a stencil printing press is stopped in a rotation phase in which the pattern-free portion of the screen comes to the lowermost position, ink is prevented from dripping through the holes of the screen.

### BACKGROUND OF THE INVENTION

1. Field of the Invention

This invention relates to a stop position control method and apparatus of a rotary stencil printing press.

2. Description of the Related Art

With a rotary screen printing press, it has been common practice to rotate the rotary screen printing press even during stoppage of printing, and use a combination of ink, which does not drip, and the size of a hole, which does not allow the ink to drip, in consideration of the viscosity of the ink and the size of the hole, so that the ink does not drip through the holes of a screen printing forme during stoppage of printing.

The conventional rotary screen printing press, however, has limitations on the type of ink which can be used, and the size of the hole. Thus, a printing product which can be produced is limited, and the rotary screen printing press has to be rotated during stoppage of printing. As a result, while printing is being stopped, an electric current flows through a motor and a motor driver, resulting in a large electric power consumption. In addition, heat occurs in the motor, thereby deteriorating grease in the motor and a bearing portion of the motor, thus shortening the lives of the motor and the motor bearing portion.

Thus, the present invention has solved the above-mentioned problems by stopping the rotation of a stencil printing press in a rotation phase in which a portion of the stencil printing plate without a pattern (i.e., a pattern-free portion) comes to a lowermost position, thereby preventing ink from dripping through the holes of the stencil printing plate. With the stencil printing press combined with a sheet-fed printing press employing other printing method, the above problems have been solved by stopping the rotation of the stencil printing press in a rotation phase in which a portion of the stencil printing plate corresponding to a portion holding a sheet or a portion holding a printing plate in the other sheet-fed printing press without a pattern comes to a lowermost position, thereby preventing ink from dripping through the holes of the stencil printing plate.

### SUMMARY OF THE INVENTION

A first aspect of the present invention is a stop position control method of a rotary stencil printing press in which a stencil printing plate is held on a rotating body, and ink is transferred through holes of the stencil printing plate, with the rotating body being rotated, to carry out printing, comprising: stopping the rotating body, in accordance with a stop signal, at a position at which a pattern-free portion of the stencil printing plate comes to a lowermost position.

A second aspect of the present invention is the stop position control method of a rotary stencil printing press according to the first aspect, wherein the rotary stencil printing press is combined with a sheet-fed printing press employing other printing method, and the pattern-free portion of the stencil printing plate is a portion corresponding to a sheet holding portion of the sheet-fed printing press employing other printing method where a sheet is held.

A third aspect of the present invention is the stop position control method of a rotary stencil printing press according to the first aspect, wherein the rotary stencil printing press is combined with a sheet-fed printing press employing other printing method, and the pattern-free portion of the stencil printing plate is a portion corresponding to a plate holding portion of the sheet-fed printing press employing other printing method where a printing plate is held.

A fourth aspect of the present invention is the stop position control method of a rotary stencil printing press according to the second or third aspect, wherein the rotary stencil printing press is equipped with a first motor for driving the sheet-fed printing press employing other printing method, and a second motor for driving the rotating body, and the second motor is controlled to be synchronized with the first motor during printing.

A fifth aspect of the present invention is the stop position control method of a rotary stencil printing press according to the fourth aspect, wherein the rotary stencil printing press is equipped with a first rotational speed detector for detecting a rotational speed of the first motor, and a second rotational speed detector for detecting a rotational speed of the second motor; speed reduction of the rotational speed of the first motor is started under a stop command; synchronous control of the second motor is released when the rotational speed detected by the first rotational speed detector becomes equal to or lower than a predetermined rotational speed, and then the second motor is controlled to stop the rotating body at the position at which the pattern-free portion of the stencil printing plate comes to the lowermost position.

A sixth aspect of the present invention is the stop position control method of a rotary stencil printing press according to the fifth aspect, wherein the predetermined rotational speed is zero.

A seventh aspect of the present invention is a stop position control apparatus of a rotary stencil printing press in which a stencil printing plate is held on a rotating body, and ink is transferred through holes of the stencil printing plate, with the rotating body being rotated, to carry out printing, comprising: a controller for stopping the rotating body, in accordance with a stop signal, at a position at which a pattern-free portion of the stencil printing plate comes to a lowermost position.

An eighth aspect of the present invention is the stop position control apparatus of a rotary stencil printing press according to the seventh aspect, wherein the rotary stencil printing press is combined with a sheet-fed printing press employing other printing method, and the pattern-free portion of the stencil printing plate is a portion corresponding to a sheet holding portion of the sheet-fed printing press employing other printing method where a sheet is held.

A ninth aspect of the present invention is the stop position control apparatus of a rotary stencil printing press according to the seventh aspect, wherein the rotary stencil printing press is combined with a sheet-fed printing press employing other printing method, and the pattern-free portion of the stencil printing plate is a portion corresponding to a plate holding portion of the sheet-fed printing press employing other printing method where a printing plate is held.

A tenth aspect of the present invention is the stop position control apparatus of a rotary stencil printing press according to the eighth or ninth aspect, further comprising: a first motor for driving the sheet-fed printing press employing other printing method, and a second motor for driving the rotating body, and wherein the controller controls the second motor to be synchronized with the first motor during printing.

An eleventh aspect of the present invention is the stop position control apparatus of a rotary stencil printing press according to the tenth aspect, further comprising: a first rotational speed detector for detecting a rotational speed of the first motor, and a second rotational speed detector for detecting a rotational speed of the second motor, and wherein the controller starts speed reduction of the rotational speed of the first motor under a stop command, releases synchronous control of the second motor when the rotational speed detected by the first rotational speed detector becomes equal to or lower than a predetermined rotational speed, and then controls the second motor to stop the rotating body at the position at which the pattern-free portion of the stencil printing plate comes to the lowermost position.

A twelfth aspect of the present invention is the stop position control apparatus of a rotary stencil printing press according to the eleventh aspect, wherein the controller sets the predetermined rotational speed at zero.

A thirteenth aspect of the present invention is the stop position control apparatus of a rotary stencil printing press according to the seventh aspect, wherein the stencil printing plate is a screen printing forme.

According to the stop position control method and apparatus of a rotary stencil printing press concerned with the present invention, the rotating body is stopped at a position at which the pattern-free portion of the stencil printing plate comes to the lowermost position. Thus, ink does not fall through the holes of the stencil printing plate.

Accordingly, the degree of freedom increases in the type of usable ink and the size of the hole. The diversification of printing products can be achieved. At a standstill of printing, moreover, the stencil printing press can also be shut down. Thus, the electric power consumption of the motor and the motor driver can be decreased, and the durability of the motor and the motor shaft bearing portion can be enhanced.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a general schematic configurational drawing of an offset sheet-fed printing press showing Embodiment 1 of the present invention;

FIG. 2 is an enlarged view of a portion II in FIG. 1;

FIG. 3 is a sectional view of a rotary screen device;

FIG. 4 is a sectional view of a plate clamping device;

FIG. 5 is an action explanation drawing;

FIG. 6 is a block diagram of a drive control device for the offset sheet-fed printing press;

FIG. 7 is a block diagram of a drive control device for a rotary screen cylinder;

FIG. 8(a) is a motion flow chart of the drive control device for the offset sheet-fed printing press;

FIG. 8(b) is a motion flow chart of the drive control device for the offset sheet-fed printing press;

FIG. 8(c) is a motion flow chart of the drive control device for the offset sheet-fed printing press;

FIG. 8(d) is a motion flow chart of the drive control device for the offset sheet-fed printing press;

FIG. 9(a) is a motion flow chart of the drive control device for the offset sheet-fed printing press;

FIG. 9(b) is a motion flow chart of the drive control device for the offset sheet-fed printing press;

FIG. 10(a) is a motion flow chart of the drive control device for the offset sheet-fed printing press;

FIG. 10(b) is a motion flow chart of the drive control device for the offset sheet-fed printing press;

FIG. 10(c) is a motion flow chart of the drive control device for the offset sheet-fed printing press;

FIG. 11 is a motion flowchart of the drive control device for the offset sheet-fed printing press;

FIG. 12(a) is a motion flow chart of the drive control device for the rotary screen cylinder;

FIG. 12(b) is a motion flow chart of the drive control device for the rotary screen cylinder;

FIG. 13(a) is a motion flow chart of the drive control device for the rotary screen cylinder;

FIG. 13(b) is a motion flow chart of the drive control device for the rotary screen cylinder;

FIG. 14 is a motion flow chart of the drive control device for the rotary screen cylinder;

FIG. 15 is a block diagram of a drive control device for an offset sheet-fed printing press showing Embodiment 2 of the present invention;

FIG. 16 is a block diagram of a drive control device for a rotary screen cylinder;

FIG. 17(a) is a motion flow chart of the drive control device for the offset sheet-fed printing press;

FIG. 17 (b) is a motion flow chart of the drive control device for the offset sheet-fed printing press;

FIG. 17(c) is a motion flow chart of the drive control device for the offset sheet-fed printing press;

FIG. 17(d) is a motion flow chart of the drive control device for the offset sheet-fed printing press;

FIG. 18 (a) is a motion flow chart of the drive control device for the offset sheet-fed printing press;

FIG. 18(b) is a motion flow chart of the drive control device for the offset sheet-fed printing press;

FIG. 19 (a) is a motion flow chart of the drive control device for the offset sheet-fed printing press;

FIG. 19(b) is a motion flow chart of the drive control device for the offset sheet-fed printing press;

FIG. 19(c) is a motion flow chart of the drive control device for the offset sheet-fed printing press;

FIG. 20 is a motion flow chart of the drive control device for the offset sheet-fed printing press;

FIG. 21(a) is a motion flow chart of the drive control device for the rotary screen cylinder;

FIG. 21(b) is a motion flow chart of the drive control device for the rotary screen cylinder;

FIG. 22 (a) is a motion flow chart of the drive control device for the rotary screen cylinder;

FIG. 22(b) is a motion flow chart of the drive control device for the rotary screen cylinder; and

FIG. 23 is a motion flowchart of the drive control device for the rotary screen cylinder.

### DETAILED DESCRIPTION OF THE INVENTION

A stop position control method and apparatus for a rotary stencil printing press according to the present invention will be described in detail by embodiments with reference to the accompanying drawings.

### Embodiment 1

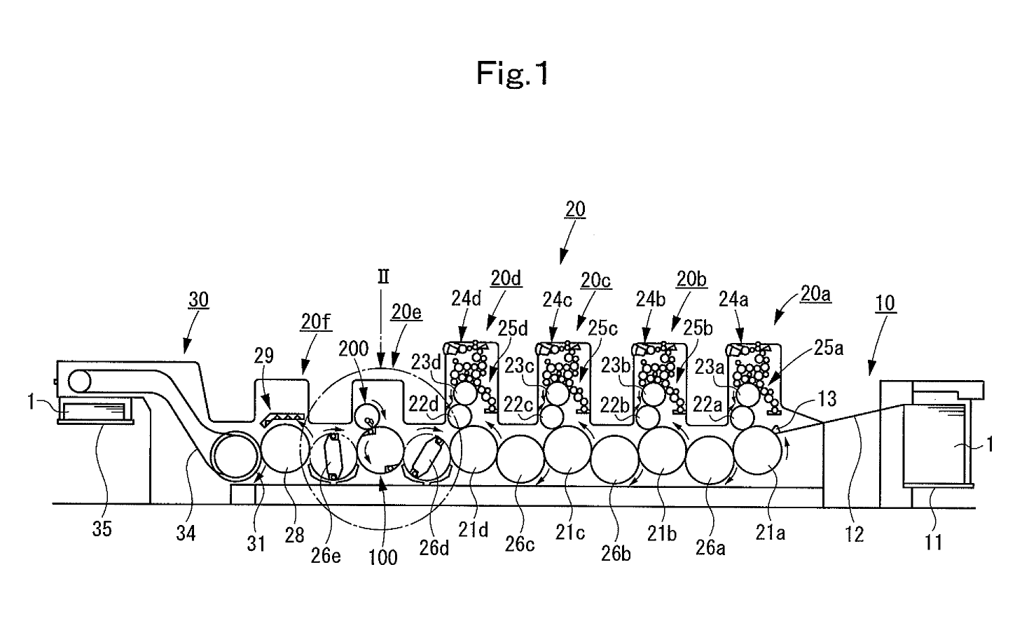

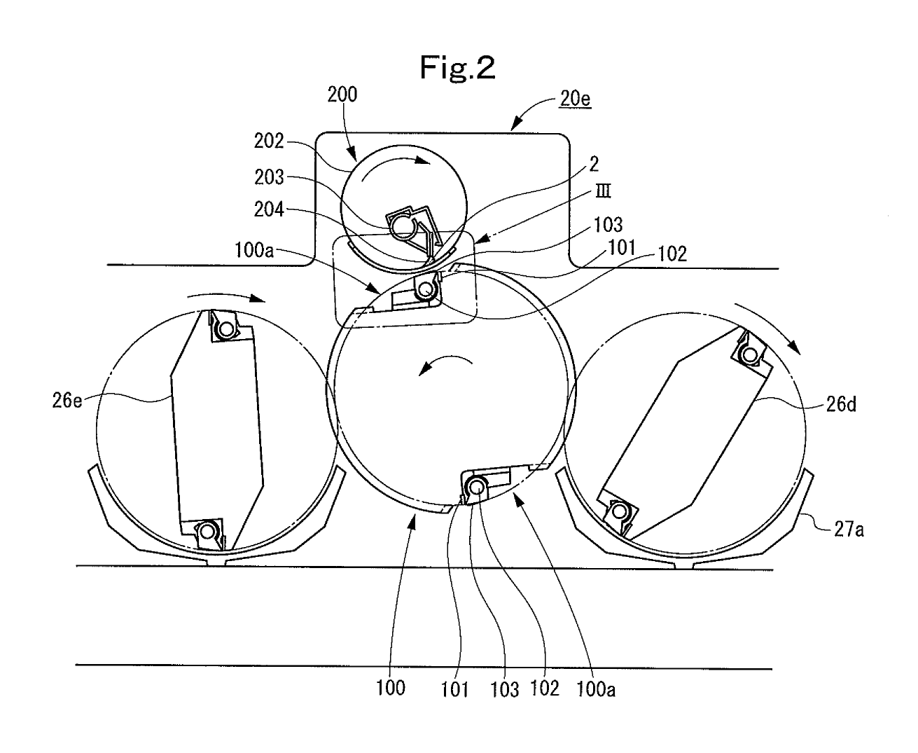

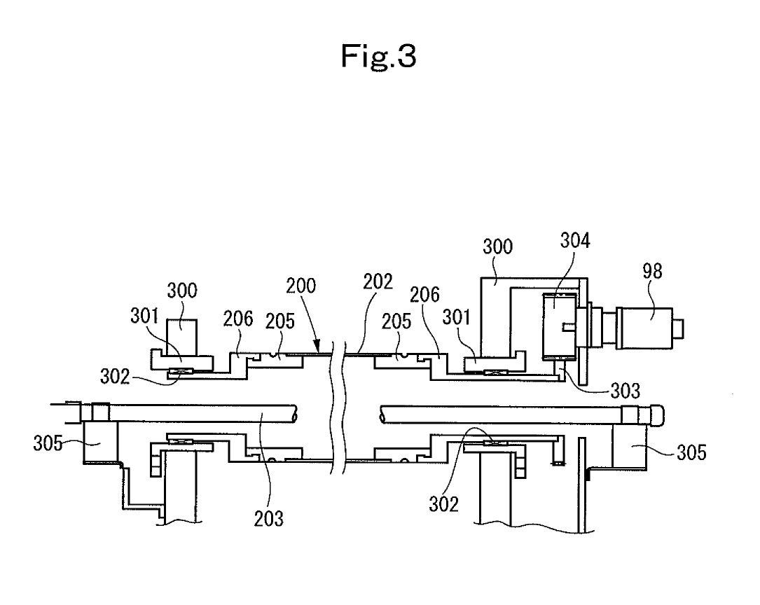

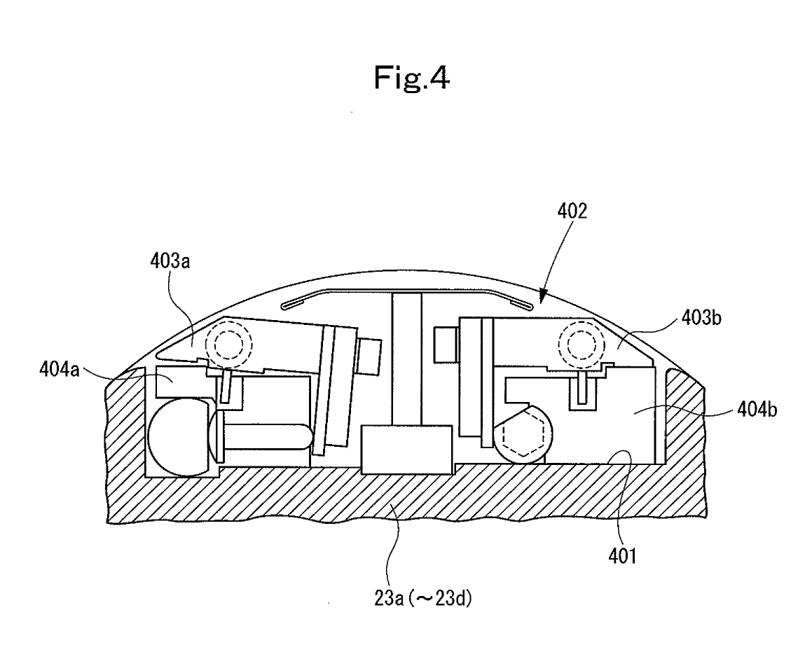

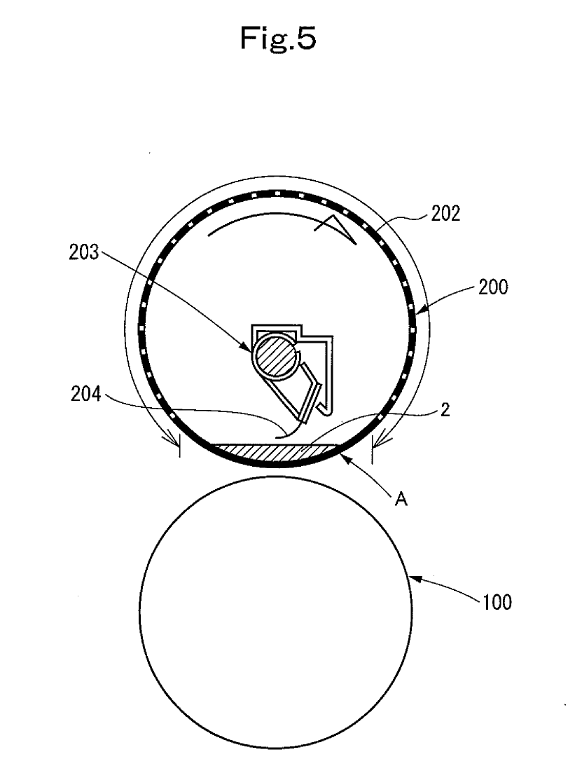

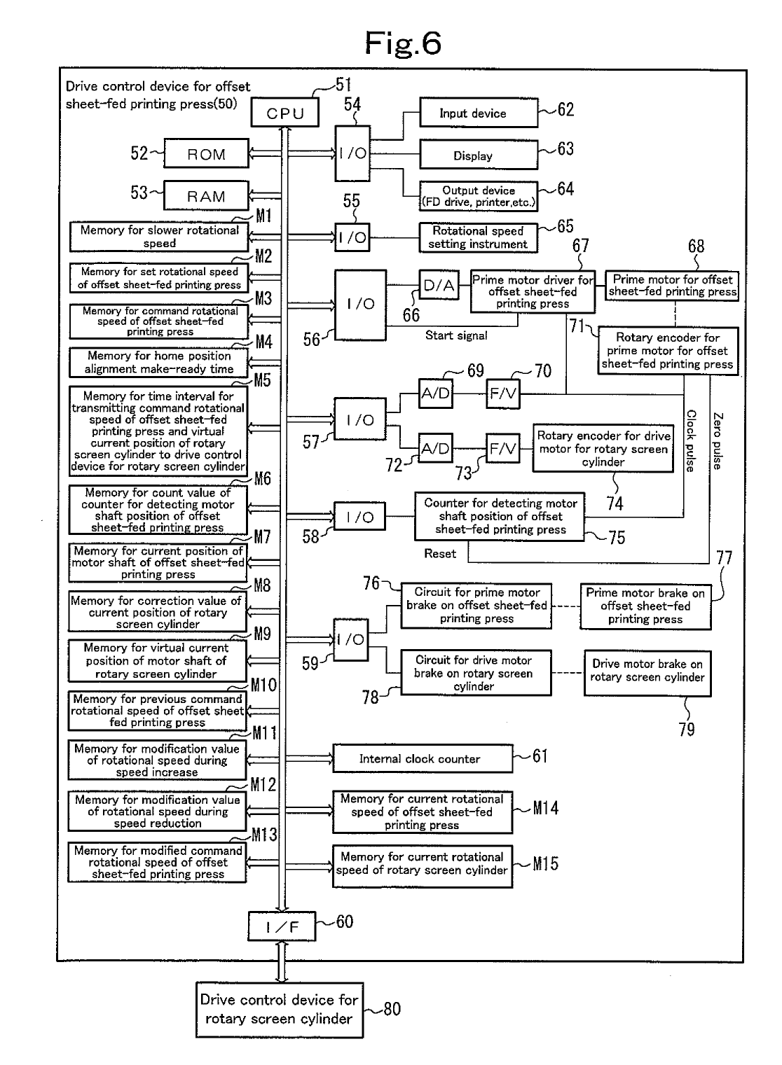

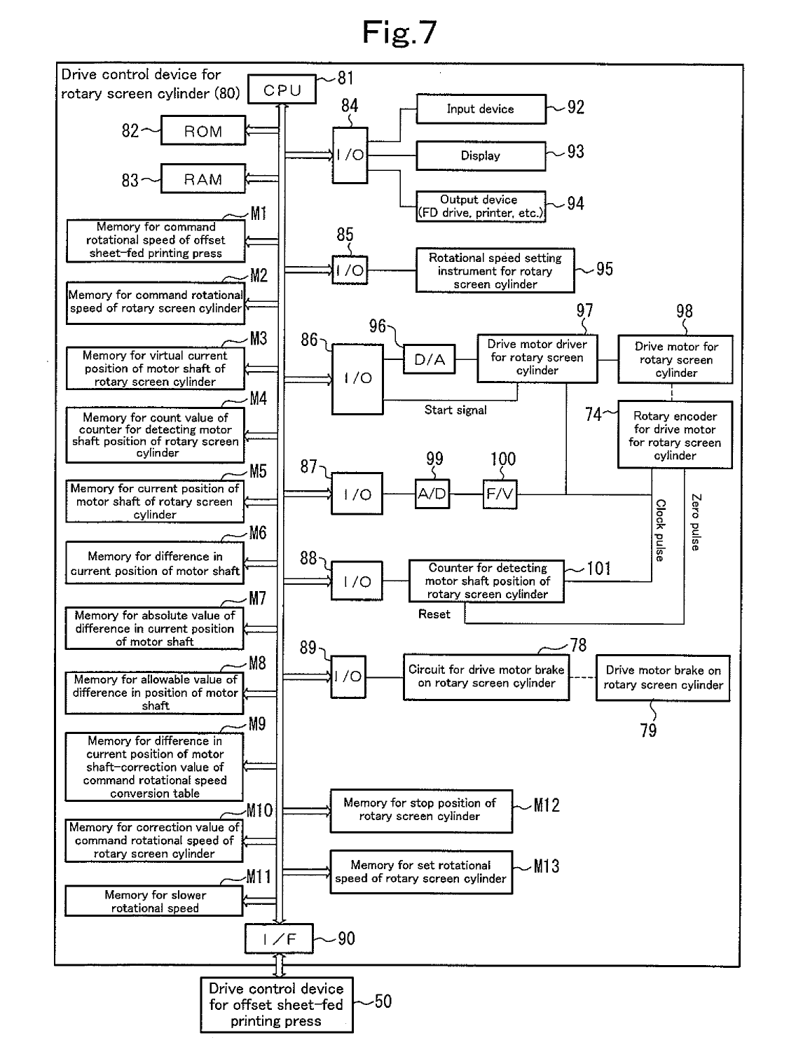

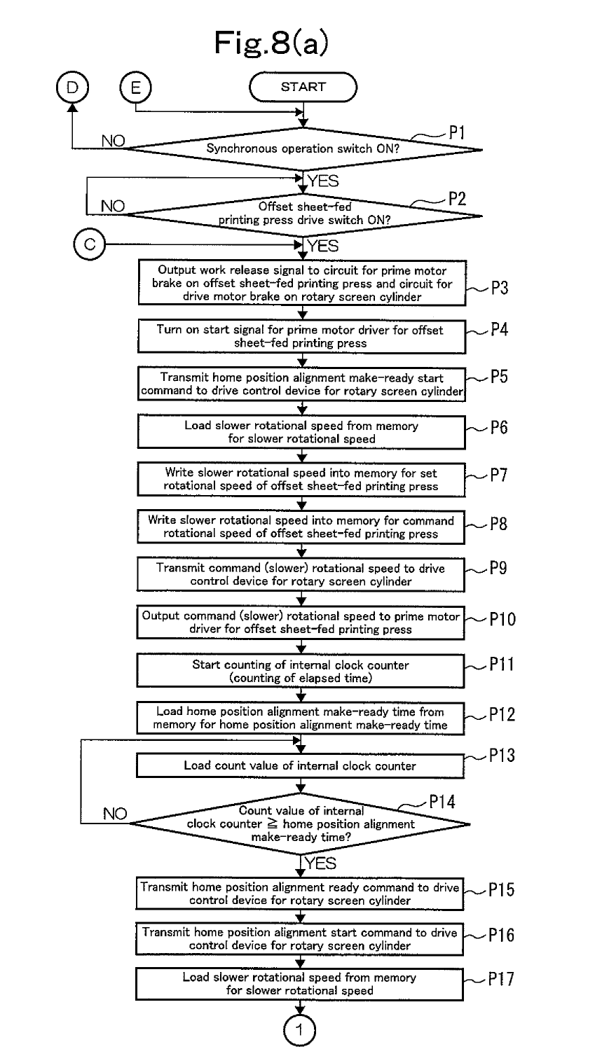

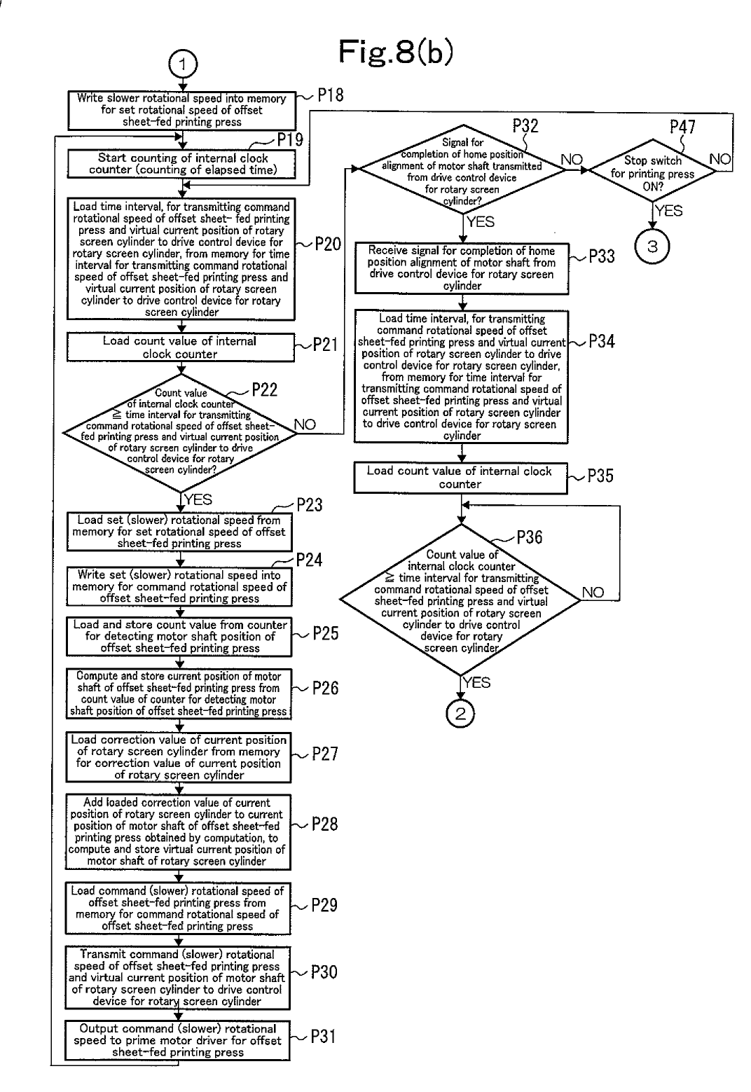

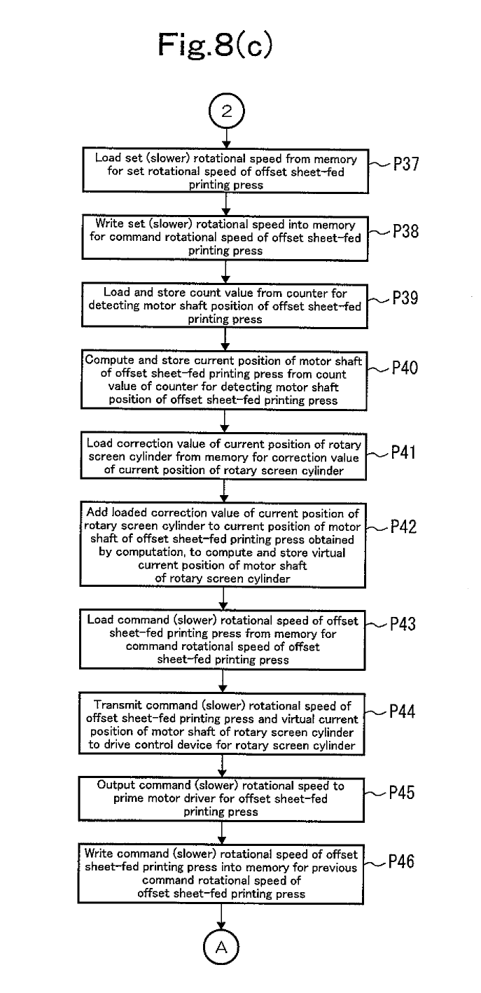

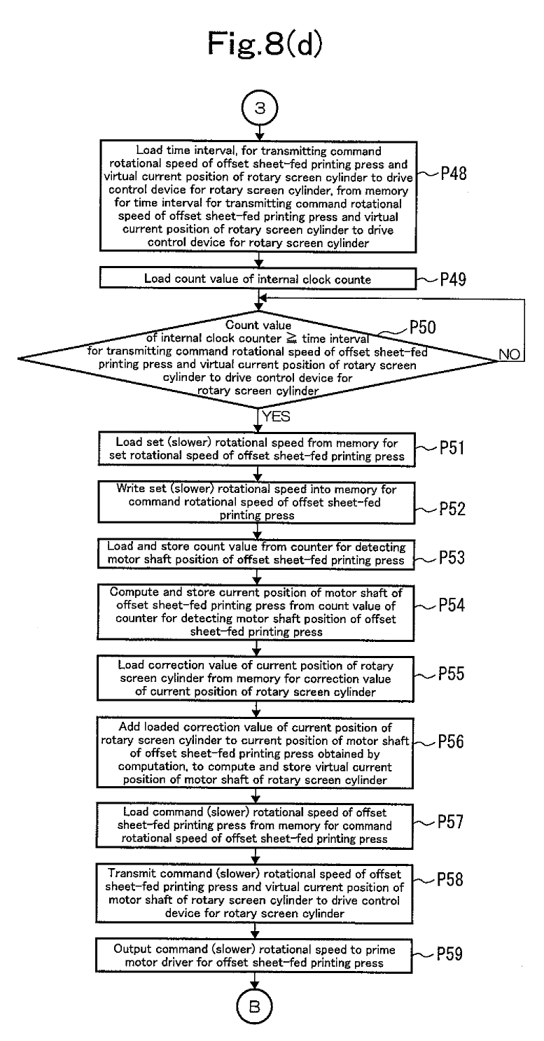

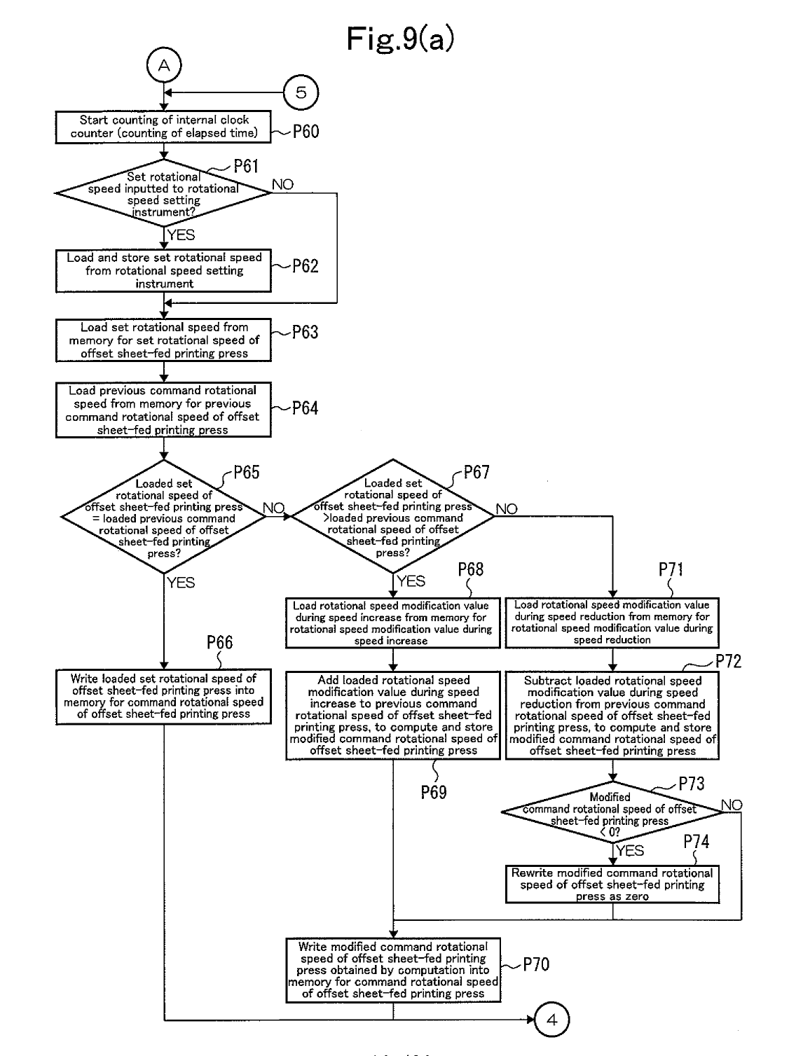

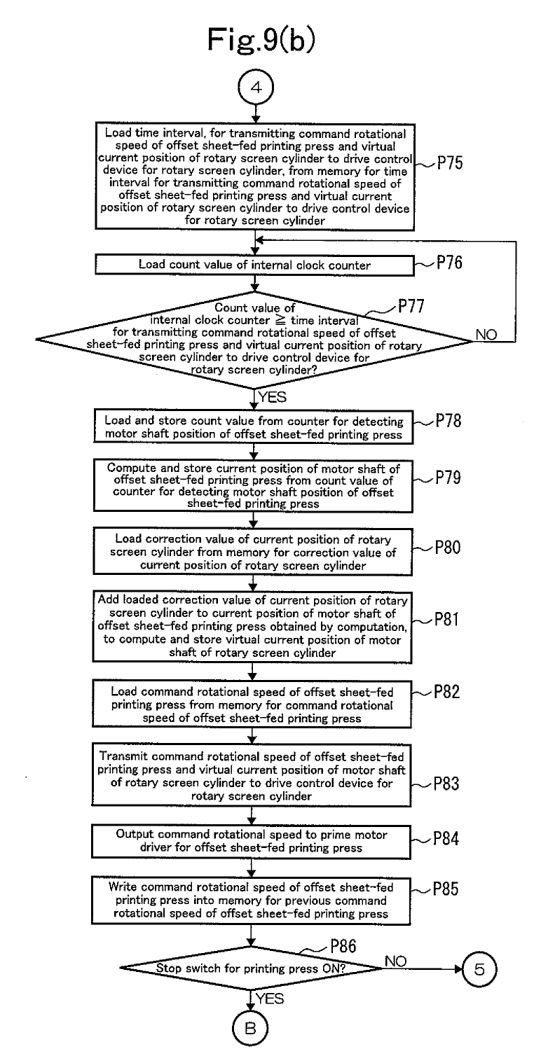

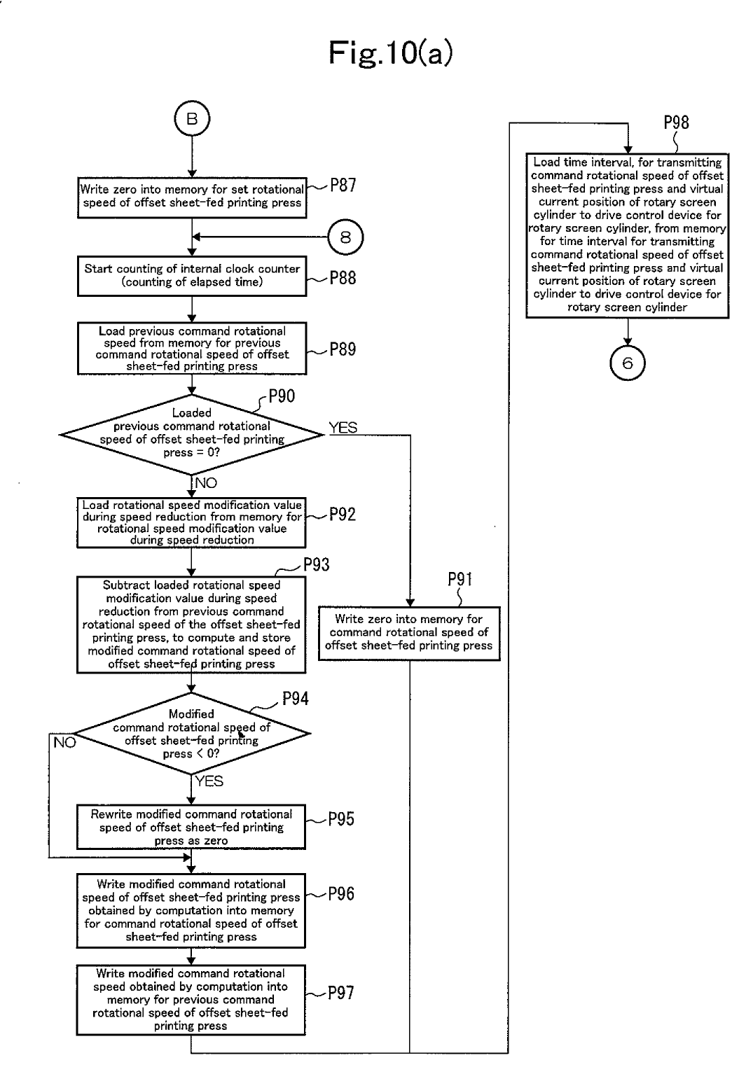

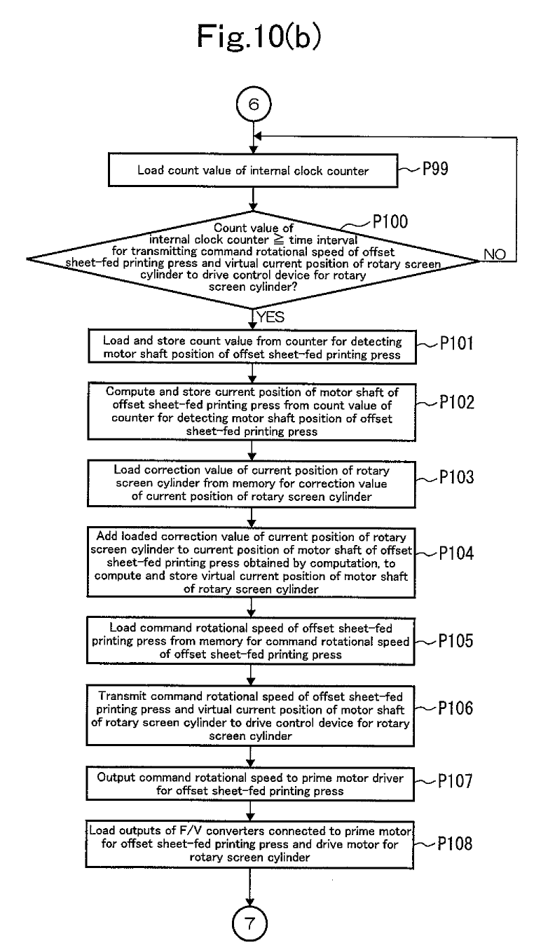

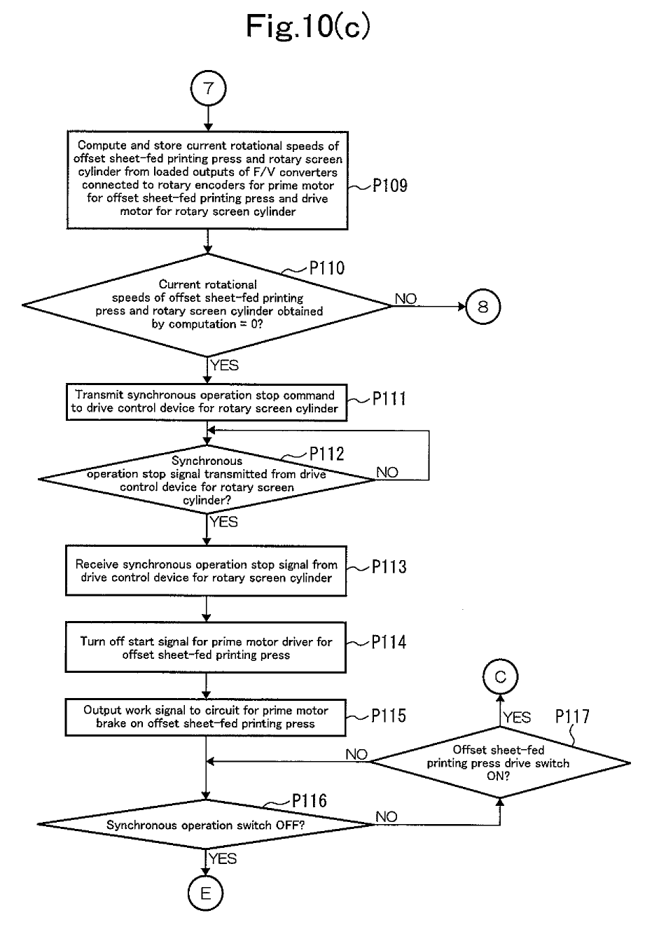

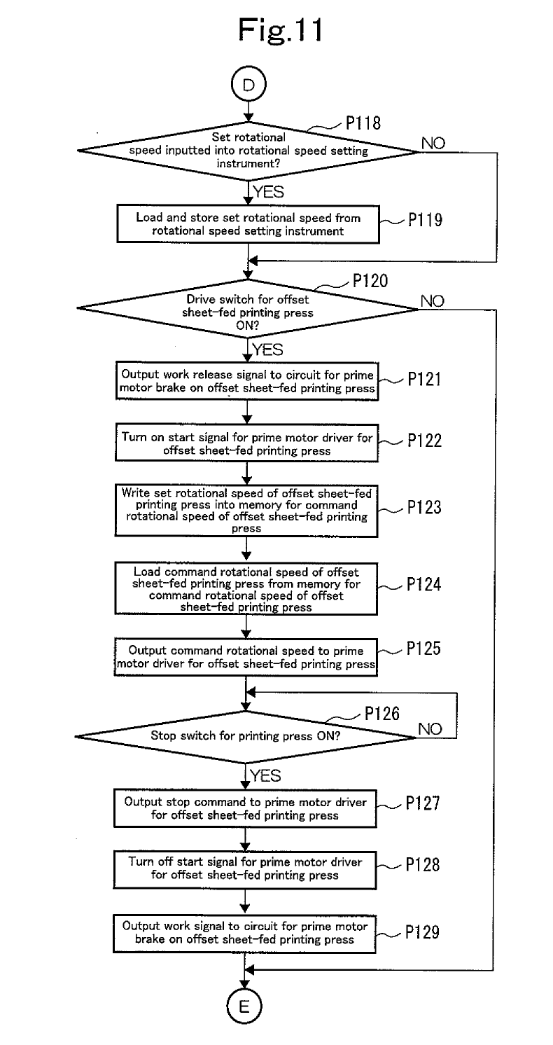

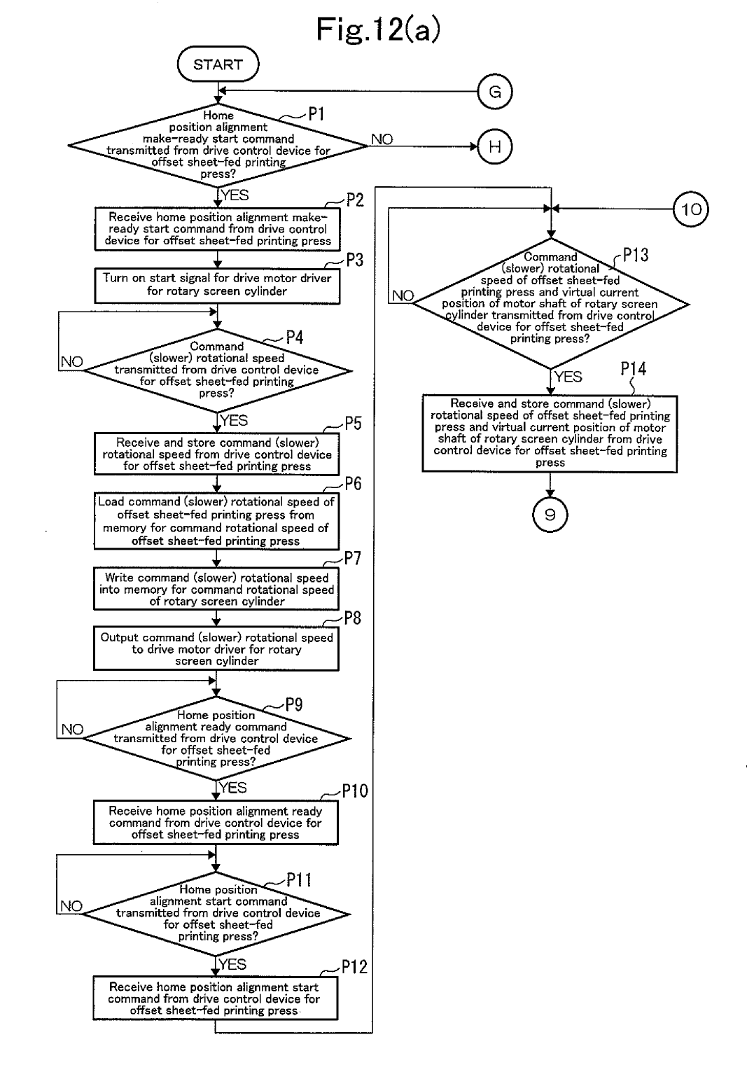

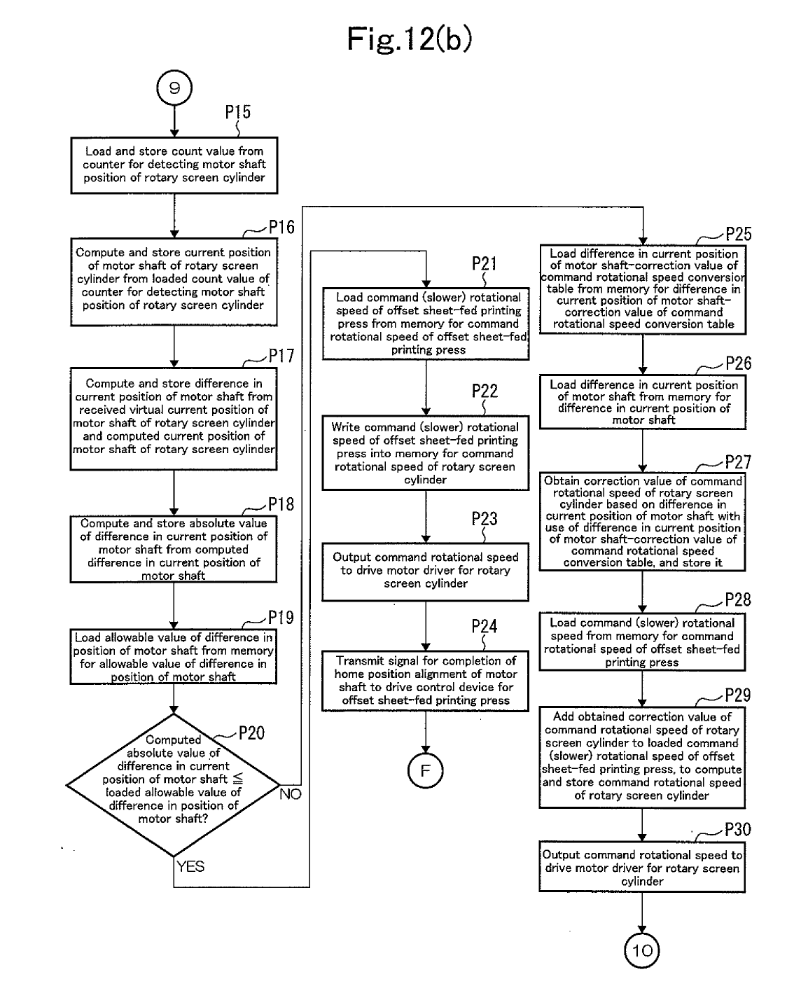

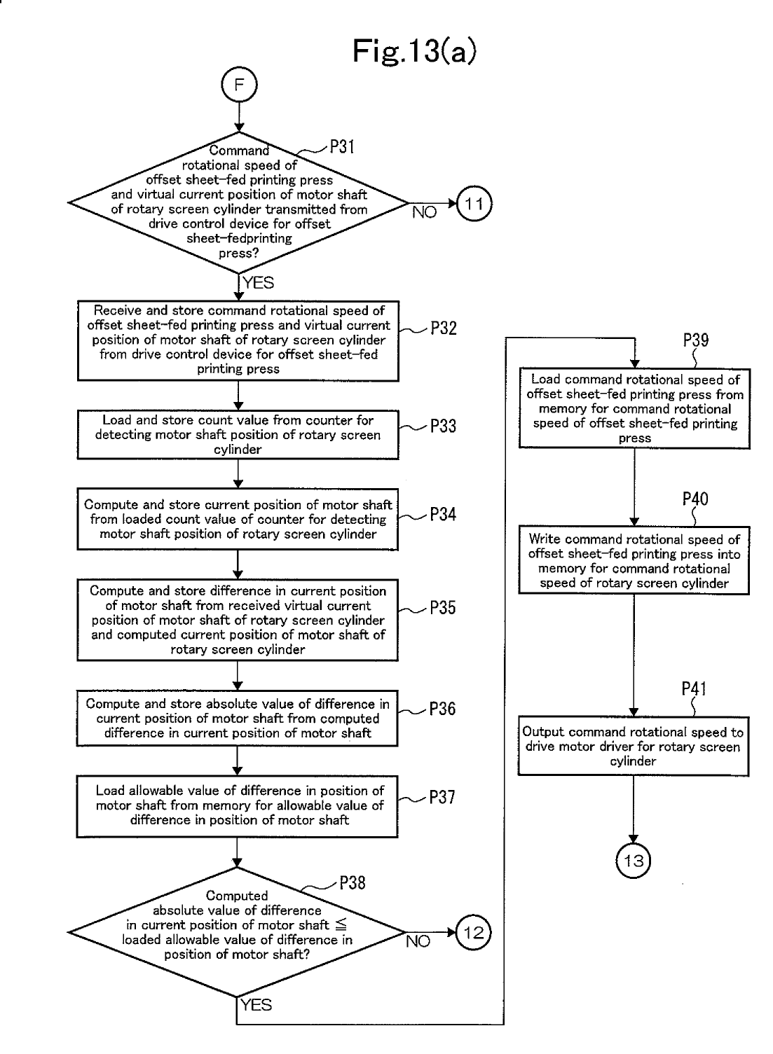

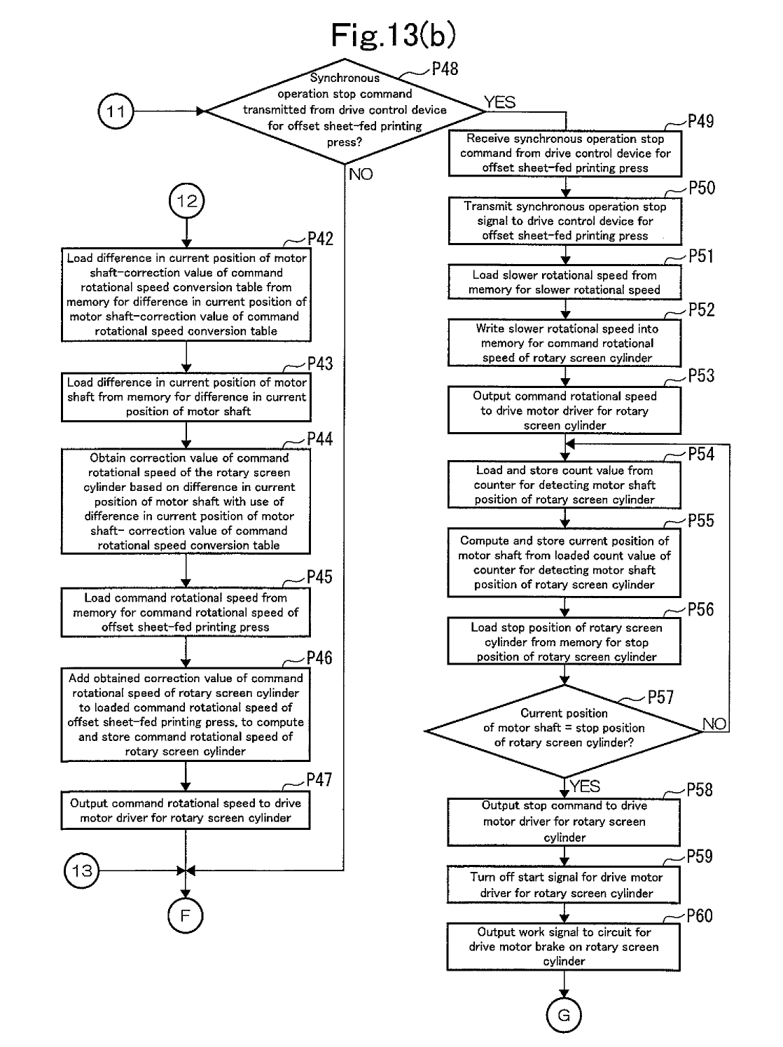

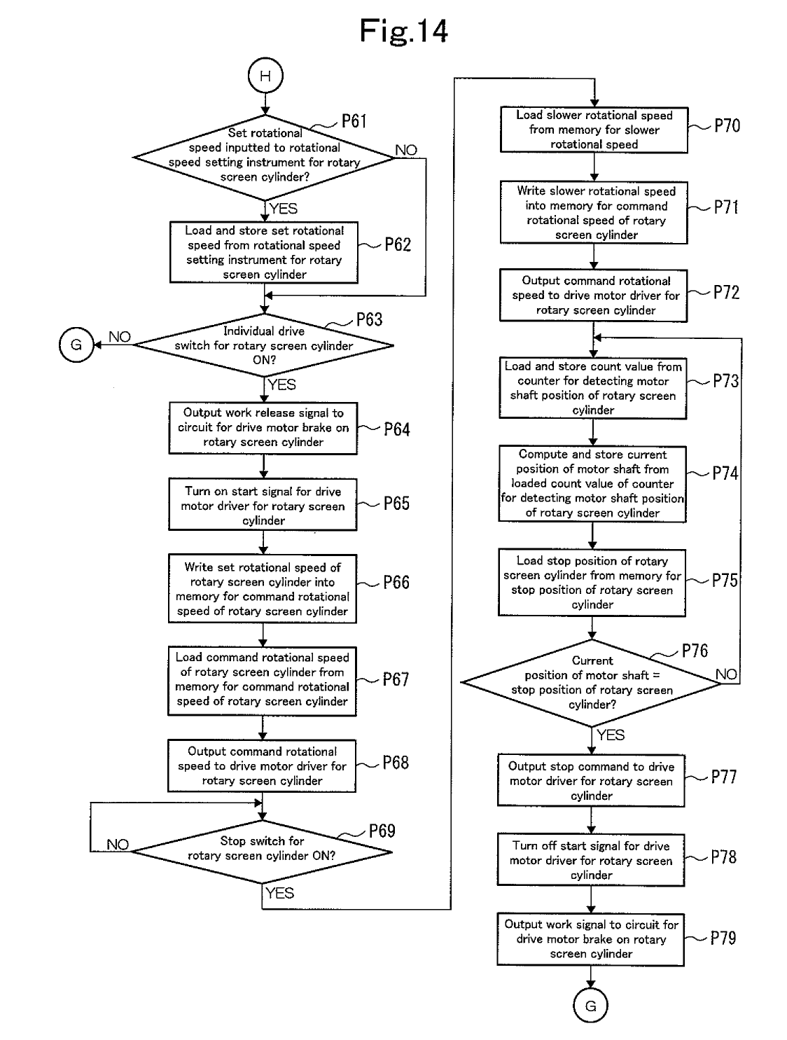

FIG. 1 is a general schematic configurational drawing of an offset sheet-fed printing press showing Embodiment 1 of the present invention. FIG. 2 is an enlarged view of a portion II in FIG. 1. FIG. 3 is a sectional view of a rotary screen device. FIG. 4 is a sectional view of a plate clamping device. FIG. 5 is an action explanation drawing. FIG. 6 is a block diagram of a drive control device for the offset sheet-fed printing press. FIG. 7 is a block diagram of a drive control device for a rotary screen cylinder. FIGS. 8 (a) to 8(d) are motion flow charts of the drive control device for the offset sheet-fed printing press. FIGS. 9(a) and 9(b) are motion flow charts of the drive control device for the offset sheet-fed printing press. FIGS. 10 (a) to 10(c) are motion flowcharts of the drive control device for the offset sheet-fed printing press. FIG. 11 is a motion flow chart of the drive control device for the offset sheet-fed printing press. FIGS. 12(a) and 12(b) are motion flow charts of the drive control device for the rotary screen cylinder. FIGS. 13(a) and 13(b) are motion flow charts of the drive control device for the rotary screen cylinder. FIG. 14 is a motion flow chart of the drive control device for the rotary screen cylinder.

As shown in FIG. 1, a feed pile board 11 is provided in a feeder 10 of an offset sheet-fed printing press (a sheet-fed printing press employing other printing method). The feeder 10 is provided with a feeder board 12 which feeds sheets 1 on the feed pile board 11, one by one, to a printing section 20. A swing arm shaft pregripper 13 for passing the sheet 1 on to an impression cylinder 21a of a first offset printing unit 20a of the printing section 20 is provided at the leading end of the feeder board 12.

A blanket cylinder 22a is in contact with a side of the impression cylinder 21a of the first offset printing unit 20a of the printing section 20 which is located downstream of the swing arm shaft pregripper 13 in the rotating direction of the impression cylinder 21a. A plate cylinder 23a is in contact with a side of the blanket cylinder 22a which is located upstream of the impression cylinder 2 la in the rotating direction of the blanket cylinder 22a. An ink supply device 24a is provided upstream of the blanket cylinder 22a in the rotating direction of the plate cylinder 23a. A dampener 25a is provided upstream of the ink supply device 24a in the rotating direction of the plate cylinder 23a.

A side of the impression cylinder 21a of the first offset printing unit 20a, which is located downstream of the blanket cylinder 22a in the rotating direction of the impression cylinder 21a, is in contact with an impression cylinder 21b of a second offset printing unit 20b via a transfer cylinder 26a. The second offset printing unit 20b is furnished with a blanket cylinder 22b, a plate cylinder 23b, an ink supply device 24b, and a dampener 25b, as is the first offset printing unit 20a.

A side of the impression cylinder 21b of the second offset printing unit 20b, which is located downstream of the blanket cylinder 22b in the rotating direction of the impression cylinder 21b, is in contact with an impression cylinder 21c of a third offset printing unit 20c via a transfer cylinder 26b. The third offset printing unit 20c is also furnished with a blanket cylinder 22c, a plate cylinder 23c, an ink supply device 24c, and a dampener 25c, as is each of the first and second offset printing units 20a and 20b.

A side of the impression cylinder 21c of the third offset printing unit 20c, which is located downstream of the blanket cylinder 22c in the rotating direction of the impression cylinder 21c, is in contact with an impression cylinder 21d of a fourth offset printing unit 20d via a transfer cylinder 26c. The fourth offset printing unit 20d is also furnished with a blanket cylinder 22d, a plate cylinder 23d, an ink supply device 24d, and a dampener 25d, as is each of the first to third offset printing units 20a to 20c.

As shown in FIGS. 1 and 2, an impression cylinder 100 of a screen printing unit (rotary stencil printing press) 20e makes contact, via a transfer cylinder 26d, with a side of the impression cylinder 21d of the fourth offset printing unit 20d which is located downstream of the blanket cylinder 22d in the rotating direction of the impression cylinder 21d, the transfer cylinder 26d comprising a skeleton cylinder (solid cylinder) below which a guide device 27a for guiding the sheet 1 in its transport by blowing air is disposed. The impression cylinder 100 has a structure as described below.

On the outer peripheral surface of the impression cylinder 100, a plurality of (two in the illustrated example) notch portions (sheet holding portions) 100a, extending along the axial direction of the impression cylinder 100, are formed with equal spacing along the circumferential direction of the impression cylinder 100, as shown in FIG. 2. On a side of the impression cylinder 100 located upstream of the notch portion 10a in the rotating direction of the impression cylinder 100 (on one side in the circumferential direction), a step portion located closer than the outer peripheral surface of the impression cylinder 100 to the axis of the impression cylinder 100 is formed along the axial direction of the impression cylinder 100. In the step portion of the impression cylinder 100, a plurality of gripper pads 101 are provided with predetermined spacing along the axial direction of the impression cylinder 101.

Within the notch portion 100a of the impression cylinder 100, a gripper shaft 102 is disposed to have its longitudinal direction along the axial direction of the impression cylinder 100. The gripper shaft 102 is supported to be rotatable with respect to the impression cylinder 100. On the gripper shaft 102, a plurality of grippers 103 are provided with predetermined spacing along the axial direction of the gripper shaft 102 such that a leading end side of the gripper 103 is situated on the gripper pad 101.

That is, the impression cylinder 100 is arranged such that the distance between its axis and the gripper pad 101 is the same as, and the distance between its axis and the top of its outer peripheral surface is greater than, the axis-gripper pad distance and the axis-outer peripheral surface top distance, respectively, in the aforementioned impression cylinders 21a to 21d, the aforementioned transfer cylinders 26a to 26d, and a transfer cylinder 26e, a transport cylinder 28, and a delivery cylinder 31 to be described later. Because of this arrangement, when the gripper 103 is closed, neither the gripper pad 101 nor the gripper 103 protrudes outwardly of the outer peripheral surface of the impression cylinder 100, so that the gripper pad 101 or the gripper 103 does not impinge on a rotary screen 202 to be described later.

As shown in FIGS. 1 and 2, a rotary screen cylinder (rotating body) of a rotary screen device 200 is in contact with a side of the impression cylinder 100 of the screen printing unit 20e which is located downstream of the transfer cylinder 26d in the rotating direction of the impression cylinder 100. The rotary screen device 200 has a structure as described below.

As shown in FIGS. 2 and 3, the rotary screen cylinder is configured in the following manner: A screen (stencil printing plate) 202 is a thin cylindrical plate material having small holes corresponding to patterns etched therein, and opposite end portions of the screen 202 are supported by cylindrical flanges 205 which are hollow cylinders. Inside the screen 202 of this rotary screen cylinder, there are provided a squeegee shaft 203 which has opposite end sides supported by frames 300 via air cylinders 305 to be movable in a diametrical direction, and which supplies special ink 2; and a squeegee 204 (see FIG. 5) which supplies the special ink 2 supplied from the squeegee shaft 203 toward the impression cylinder 100 through the small holes of the screen 202.

The rotary screen cylinder of the above rotary screen device 200 is supported between the frames 300 to be rotationally drivable and detachable because of the following structure:

As shown in FIG. 3, stepped tubular holders 206 are connected to the paired flanges 205, and small-diameter tubular portions of these holders 206 are rotatably supported by eccentric bearings 301 via bearings 302. These eccentric bearings 301 are rotatably supported by the frames 300.

The eccentric bearing 301 is rotationally driven by a throw-on and throw-off actuator (not shown), and its eccentric rotation allows the rotary screen cylinder of the rotary screen device 200 to be thrown on and thrown off the impression cylinder 100. FIG. 5 shows a state in which the rotary screen cylinder of the rotary screen device 200 has been thrown off the impression cylinder 100 when printing is stopped.

In the present embodiment, the rotary screen cylinder of the rotary screen device 200 is rotationally driven by a dedicated drive motor (second motor) 98, separately from the offset sheet-fed printing press which is driven by a prime motor (first motor) 68 (see FIG. 6). As shown in FIG. 3, a gear 303 secured to the small-diameter tubular portion of one of the holders 206 meshes with a gear 304 secured to the output shaft of the drive motor 98. The impression cylinder 100 opposing the rotary screen cylinder is rotationally driven by the prime motor 68 for the offset sheet-fed printing press via a gear train, as in the conventional offset sheet-fed printing press.

During printing, the drive motor 98 and the prime motor 68 are synchronously controlled by a drive control device (controller) 50 for the offset sheet-fed printing press (to be described later) and a drive control device (controller) 80 for the rotary screen cylinder (to be described later) such that a pattern-free portion (hole-free portion) A of the screen 202 and the notch portion (sheet holding portion) 100a of the impression cylinder 100 are always opposed to each other while rotation is being made.

The pattern-free portion (hole-free portion) A in the screen 202 is a portion corresponding to a plate clamping device (plate holding portion) 402 of the plate cylinder 23a (to 23d), and their rotation phases may be synchronized. As shown in FIG. 4, the plate clamping device 402 comprises a leading edge plate clamp and a trailing edge plate clamp embedded, back to back, in a notch 401 of the plate cylinder 23a (to 23d), the leading edge plate clamp comprising a gripper board 403a and a clamp pad 404a, and the trailing edge plate clamp comprising a gripper board 403b and a clamp pad 404b.

In the present offset sheet-fed printing press, therefore, the sheets 1 are fed, one by one, from the feed pile board 11 onto the feeder board 12 in the feeder 10. The sheet 1 is passed by the swing arm shaft pregripper 13 on to the impression cylinder 21a of the first offset printing unit 20a in the printing section 20. Separately, ink and dampening water are supplied from the ink supply device 24a and the dampener 25a of the first offset printing unit 20a to the plate cylinder 23a, and then supplied from the plate cylinder 23a to the blanket cylinder 22a. As a result, ink is transferred from the blanket cylinder 22a to the sheet 1, so that the sheet 1 is printed in a first color. Then, the sheet 1 is passed via the transfer cylinder 26a on to the impression cylinder 21b of the second offset printing unit 20b, and is printed in a second color in the second offset printing unit 20b as in the first offset printing unit 20a. Subsequently, the sheet 1 is printed similarly in a third color and a fourth color in the third and fourth offset printing units 20c and 20d.

Then, the sheet 1 is subjected to gripping change by the gripper pad 101 and the gripper 103 of the impression cylinder 100 of the screen printing unit 20e via the transfer cylinder 26d. In the rotary screen device 200 of the screen printing unit 20e, the screen 202 is rotated in accordance with the rotation of the impression cylinder 100, and the special ink 2 from the squeegee shaft 203 is transferred and supplied through the small holes of the screen 202 by the squeegee 204. Thus, the sheet 1 is printed in a thick layer of the special ink 2 corresponding to the small holes of the screen 202. Then, the sheet 1 is passed from the impression cylinder 100 on to a transport cylinder 28 of a drying unit 20f via the transfer cylinder 26e to have the printed special ink 2 dried by UV from a drying lamp 29. Then, the sheet 1 is passed on to a delivery cylinder 31 of a delivery unit 30, from which the sheet 1 is transported by a delivery chain 34 via delivery grippers for delivery onto a delivery pile board 35.

In the present embodiment, the drive control device (controller) 50 for the offset sheet-fed printing press and the drive control device (controller) 80 for the rotary screen cylinder start the speed reduction of the rotational speed of the prime motor 68 under a stop command. When the rotational speed detected by a rotary encoder (first rotational speed detector) 71 is zero, synchronous control of the drive motor 98 is released. Then, the drive motor 98 is controlled to stop the rotary screen cylinder of the rotary screen device 200 at such a position that the pattern-free portion (hole-free portion) A in the screen 202 comes to the lowermost position.

As shown in FIG. 6, the drive control device 50 for the offset sheet-fed printing press has a CPU 51, an ROM 502, an RAM 53, input/output devices 54 to 59, and an interface 60 connected by a BUS line.

To the BUS line, the following memories are connected in addition to an internal clock counter 61: A memory M1 for a slower rotational speed; a memory M2 for the set rotational speed of the offset sheet-fed printing press; a memory M3 for the command rotational speed of the offset sheet-fed printing press; a memory M4 for a home position alignment make-ready time; a memory M5 for a time interval for transmitting the command rotational speed of the offset sheet-fed printing press and the virtual current position of the rotary screen cylinder to the drive control device for the rotary screen cylinder, a memory MG for the count value of a counter for detecting the motor shaft position of the offset sheet-fed printing press; and a memory M7 for the current position of the motor shaft of the offset sheet-fed printing press.

To the BUS line, the following memories are further connected: A memory M8 for the correction value of the current position of the rotary screen cylinder; a memory M9 for the virtual current position of the motor shaft of the rotary screen cylinder; a memory M10 for the previous command rotational speed of the offset sheet-fed printing press; a memory M11 for the modification value of the rotational speed during speed increase; a memory M12 for the modification value of the rotational speed during speed reduction; a memory M13 for the modified command rotational speed of the offset sheet-fed printing press; a memory M14 for the current rotational speed of the offset sheet-fed printing press; and a memory M15 for the current rotational speed of the rotary screen cylinder.

To the input/output device 54, there are connected an input device 62 such as a keyboard, various switches and buttons, a display 63 such as a CRT or a lamp, and an output device 64 such as a printer or a floppy disk (registered trademark) drive. A rotational speed setting instrument 65 is connected to the input/output device 55.

To the input/output device 56, a prime motor driver 67 for the offset sheet-fed printing press is connected via a D/A converter 66. A prime motor 68 for the offset sheet-fed printing press, and a rotary encoder 71 for the prime motor for the offset sheet-fed printing press are connected to the prime motor driver 67.

To the input/output device 57, the rotary encoder 71 for the prime motor for the offset sheet-fed printing press is connected via an A/D converter 69 and an F/V converter 70, and a rotary encoder (second rotational speed detector) 74 for the drive motor for the rotary screen cylinder is connected via an A/D converter 72 and an F/V converter 73.

To the input/output device 58, a counter 75 for detecting the motor shaft position of the offset sheet-fed printing press is connected. The rotary encoder 71 for the prime motor for the offset sheet-fed printing press is connected to the counter 75.

To the input/output device 59, a prime motor brake 77 on the offset sheet-fed printing press is connected via a circuit 76 for the prime motor brake on the offset sheet-fed printing press, and a drive motor brake 79 on the rotary screen cylinder is connected via a circuit 78 for the drive motor brake on the rotary screen cylinder. The drive control device 80 for the rotary screen cylinder to be described later is connected to the interface 60.

As shown in FIG. 7, the drive control device 80 for the rotary screen cylinder comprises a CPU 81, an ROM 82, an RAM 83, input/output devices 84 to 89, and an interface 90 connected by a BUS line.

To the BUS line, the following memories are connected: A memory M1 for the command rotational speed of the offset sheet-fed printing press; a memory M2 for the command rotational speed of the rotary screen cylinder; a memory M3 for the virtual current position of the motor shaft of the rotary screen cylinder; a memory M4 for the count value of a counter for detecting the motor shaft position of the rotary screen cylinder; a memory M5 for the current position of the motor shaft of the rotary screen cylinder; a memory MG for a difference in the current position of the motor shaft; and a memory M7 for the absolute value of the difference in the current position of the motor shaft.

To the BUS line, the following memories are further connected: A memory M8 for the allowable value of the difference in the position of the motor shaft; a memory M9 for a conversion table of the difference in the current position of the motor shaft-correction value of the command rotational speed (i.e., difference in current position of motor shaft-correction value of command rotational speed conversion table); a memory M10 for the correction value of the command rotational speed of the rotary screen cylinder; a memory M11 for a slower rotational speed; a memory M12 for the stop position of the rotary screen cylinder; and a memory M13 for the set rotational speed of the rotary screen cylinder. The stop position of the rotary screen cylinder, which is stored in the memory M12 for the stop position of the rotary screen cylinder, is the position where the hole-free portion A of the rotary screen 202 comes to the lowermost position, as shown in FIG. 5.

To the input/output device 84, there are connected an input device 92 such as a keyboard, various switches and buttons, a display 93 such as a CRT or a lamp, and an output device 94 such as a printer or a floppy disk (registered trademark) drive. A rotational speed setting instrument 95 for the rotary screen cylinder is connected to the input/output device 85.

To the input/output device 86, a drive motor driver 97 for the rotary screen cylinder is connected via a D/A converter 96. A drive motor 98 for the rotary screen cylinder and a rotary encoder 74 for the drive motor for the rotary screen cylinder are connected to the drive motor driver 97.

To the input/output device 87, the rotary encoder 74 for the drive motor for the rotary screen cylinder is connected via an A/D converter 99 and an F/V converter 100. To the input/output device 88, a counter 101 for detecting the motor shaft position of the rotary screen cylinder is connected. The rotary encoder 74 for the drive motor for the rotary screen cylinder is connected to the counter 101.

To the input/output device 89, a drive motor brake 79 on the rotary screen cylinder is connected via a circuit 78 for the drive motor brake on the rotary screen cylinder. The aforementioned drive control device 50 for the offset sheet-fed printing press is connected to the interface 90.

Because of the above-described features, in controlling the rotary screen cylinder in synchronization with the offset sheet-fed printing press, the drive control device 50 for the offset sheet-fed printing press acts in accordance with the motion flows shown in FIGS. 8(a) to 8(d), 9(a) and 9(b) 10(a) to 10(c), and 11.

In Step P1, it is determined whether a synchronous operation switch is ON. If ON, it is determined in Step P2 whether an offset sheet-fed printing press drive switch is ON. If not ON in Step P1, the program shifts to Step P118 to be described later. If ON in Step P2, a work release signal is outputted to the circuit 76 for the prime motor brake on the offset sheet-fed printing press and the circuit 78 for the drive motor brake on the rotary screen cylinder in Step P3. Then, in Step P4, a start signal for the prime motor driver 67 for the offset sheet-fed printing press is turned on. Then, in Step P5, a home position alignment make-ready start command is transmitted to the drive control device 80 for the rotary screen cylinder.

Then, in Step P6, a slower rotational speed is loaded from the memory M1 for the slower rotational speed. In Step P7, the slower rotational speed is written into the memory M2 for the set rotational speed of the offset sheet-fed printing press. Then, in Step P8, the slower rotational speed is written into the memory M3 for the command rotational speed of the offset sheet-fed printing press. Then, in Step P9, the command (slower) rotational speed is transmitted to the drive control device 80 for the rotary screen cylinder.

Then, in Step P10, the command (slower) rotational speed is outputted to the prime motor driver 67 for the offset sheet-fed printing press. Then, in Step P11, counting of the internal clock counter (counting of the elapsed time) 61 is started. Then, in Step P12, the home position alignment make-ready time is loaded from the memory M4 for the home position alignment make-ready time. In Step P13, the count value of the internal clock counter 61 is loaded.

If, in Step P14, the count value of the internal clock counter 61 is equal to or greater than the home position alignment make-ready time, a home position alignment ready command is transmitted to the drive control device 80 for the rotary screen cylinder in Step P15. Then, in Step P16, a home position alignment start command is transmitted to the drive control device 80 for the rotary screen cylinder. Then, in Step P17, the slower rotational speed is loaded from the memory M1 for the slower rotational speed.

Then, in Step P18, the slower rotational speed is written into the memory M2 for the set rotational speed of the offset sheet-fed printing press. Thereafter, in Step P19, counting of the internal clock counter (counting of the elapsed time) 61 is started. Then, in Step P20, the time interval for transmitting the command rotational speed of the offset sheet-fed printing press and the virtual current position of the rotary screen cylinder to the drive control device 80 for the rotary screen cylinder are loaded from the memory MS for the time interval for transmitting the command rotational speed of the offset sheet-fed printing press and the virtual current position of the rotary screen cylinder to the drive control device for the rotary screen cylinder. In Step P21, the count value of the internal clock counter 61 is loaded.

Then, in Step P22, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, the set (slower) rotational speed is loaded from the memory M2 for the set rotational speed of the offset sheet-fed printing press in Step P23. Then, in Step P24, the set (slower) rotational speed is written into the memory M3 for the command rotational speed of the offset sheet-fed printing press. Afterwards, in Step P25, the count value is loaded from the counter 75 for detecting the motor shaft position of the offset sheet-fed printing press, and stored into the memory M6.

Then, in Step P26, the current position of the motor shaft of the offset sheet-fed printing press is computed from the count value of the counter 75 for detecting the motor shaft position of the offset sheet-fed printing press, and stored into the memory M7. Then, in Step P27, the correction value of the current position of the rotary screen cylinder is loaded from the memory M8 for the correction value of the current position of the rotary screen cylinder.

Then, in Step P28, the loaded correction value of the current position of the rotary screen cylinder is added to the current position of the motor shaft of the offset sheet-fed printing press obtained by the above computation, whereby the virtual current position of the motor shaft of the rotary screen cylinder is computed and stored into the memory M9. Then, in Step P29, the command (slower) rotational speed of the offset sheet-fed printing press is loaded from the memory M3 for the command rotational speed of the offset sheet-fed printing press. Then, in Step P30, the command (slower) rotational speed of the offset sheet-fed printing press and the virtual current position of the motor shaft of the rotary screen cylinder are transmitted to the drive control device 80 for the rotary screen cylinder. Then, in Step P31, the command (slower) rotational speed is outputted to the prime motor driver 67 for the offset sheet-fed printing press. Afterwards, the program returns to Step P19.

If the answer is NO in Step P22, it is determined in Step P32 whether a signal for completion of home position alignment of the motor shaft has been transmitted from the drive control device 80 for the rotary screen cylinder. If the answer is YES, the signal for completion of home position alignment of the motor shaft is received from the drive control device 80 for the rotary screen cylinder in Step P33. Then, in Step P34, the time interval for transmitting the command rotational speed of the offset sheet-fed printing press and the virtual current position of the rotary screen cylinder to the drive control device 80 for the rotary screen cylinder are loaded from the memory M5 for the time interval for transmitting the command rotational speed of the offset sheet-fed printing press and the virtual current position of the rotary screen cylinder to the drive control device for the rotary screen cylinder. In Step P35, the count value of the internal clock counter 61 is loaded.

Then, in Step P36, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, the set (slower) rotational speed is loaded from the memory M2 for the set rotational speed of the offset sheet-fed printing press in Step P37. Then, in Step P38, the set (slower) rotational speed is written into the memory M3 for the command rotational speed of the offset sheet-fed printing press. Afterwards, in Step P39, the count value is loaded from the counter 75 for detecting the motor shaft position of the offset sheet-fed printing press, and stored into the memory MG.

Then, in Step P40, the current position of the motor shaft of the offset sheet-fed printing press is computed from the count value of the counter 75 for detecting the motor shaft position of the offset sheet-fed printing press, and stored into the memory M7. Then, in Step P41, the correction value of the current position of the rotary screen cylinder is loaded from the memory M8 for the correction value of the current position of the rotary screen cylinder. Then, in Step P42, the loaded correction value of the current position of the rotary screen cylinder is added to the current position of the motor shaft of the offset sheet-fed printing press obtained by the above computation, whereby the virtual current position of the motor shaft of the rotary screen cylinder is computed and stored into the memory M9. Then, in Step P43, the command (slower) rotational speed of the offset sheet-fed printing press is loaded from the memory M3 for the command rotational speed of the offset sheet-fed printing press.

Then, in Step P44, the command (slower) rotational speed of the offset sheet-fed printing press and the virtual current position of the motor shaft of the rotary screen cylinder are transmitted to the drive control device 80 for the rotary screen cylinder. Then, in Step P45, the command (slower) rotational speed is outputted to the prime motor driver 67 for the offset sheet-fed printing press. Then, in Step P46, the command (slower) rotational speed of the offset sheet-fed printing press is written into the memory M10 for the previous command rotational speed of the offset sheet-fed printing press, where after the program shifts to Step P60.

If the answer is NO in Step P32, it is determined in Step P47 whether the stop signal for the printing press has been inputted. If the answer is NO, the program returns to Step P20. If the answer is YES, the time interval for transmitting the command rotational speed of the offset sheet-fed printing press and the virtual current position of the rotary screen cylinder to the drive control device 80 for the rotary screen cylinder are loaded in Step P48 from the memory M5 for the time interval for transmitting the command rotational speed of the offset sheet-fed printing press and the virtual current position of the rotary screen cylinder to the drive control device for the rotary screen cylinder. In Step P49, the count value of the internal clock counter 61 is loaded.

Then, in Step P50, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, the set (slower) rotational speed is loaded from the memory M2 for the set rotational speed of the offset sheet-fed printing press in Step P51. Then, in Step P52, the set (slower) rotational speed is written into the memory M3 for the command rotational speed of the offset sheet-fed printing press. Afterwards, in Step P53, the count value is loaded from the counter 75 for detecting the motor shaft position of the offset sheet-fed printing press, and stored into the memory M6.

Then, in Step P54, the current position of the motor shaft of the offset sheet-fed printing press is computed from the count value of the counter 75 for detecting the motor shaft position of the offset sheet-fed printing press, and stored into the memory M7. Then, in Step P55, the correction value of the current position of the rotary screen cylinder is loaded from the memory M8 for the correction value of the current position of the rotary screen cylinder. Then, in Step P56, the loaded correction value of the current position of the rotary screen cylinder is added to the current position of the motor shaft of the offset sheet-fed printing press obtained by the above computation, whereby the virtual current position of the motor shaft of the rotary screen cylinder is computed and stored into the memory M9. Then, in Step P57, the command (slower) rotational speed of the offset sheet-fed printing press is loaded from the memory M3 for the command rotational speed of the offset sheet-fed printing press.

Then, in Step P58, the command (slower) rotational speed of the offset sheet-fed printing press and the virtual current position of the motor shaft of the rotary screen cylinder are transmitted to the drive control device 80 for the rotary screen cylinder. Then, in Step P59, the command (slower) rotational speed is outputted to the prime motor driver 67 for the offset sheet-fed printing press. Then, the program shifts to Step P87 to be described later.

Then, in the aforementioned Step P60, counting of the internal clock counter (counting of the elapsed time) 61 is started. If, in the subsequent Step P61, the set rotational speed has been inputted to the rotational speed setting instrument 65, the set rotational speed is loaded from the rotational speed setting instrument 65, and stored into the memory M2, in Step P62. Then, in Step P63, the set rotational speed is loaded from the memory M2 for the set rotational speed of the offset sheet-fed printing press, whereafter the previous command rotational speed is loaded from M10 for the previous command rotational speed of the offset sheet-fed printing press in Step P64.

Then, in Step P65, it is determined whether the loaded set rotational speed of the offset sheet-fed printing press is equal to the loaded previous command rotational speed of the offset sheet-fed printing press. If the answer is YES, in Step P66 the loaded set rotational speed of the offset sheet-fed printing press is written into the memory M3 for the command rotational speed of the offset sheet-fed printing press. Then, the program shifts to Step P75.

If the answer is NO in the above Step P65, it is determined in Step P67 whether the loaded set rotational speed of the offset sheet-fed printing press is higher than the loaded previous command rotational speed of the offset sheet-fed printing press. If the answer is YES, the rotational speed modification value during speed increase is loaded in Step P68 from the memory M11 for the rotational speed modification value during speed increase. Then, in Step P69, the loaded rotational speed modification value during speed increase is added to the previous command rotational speed of the offset sheet-fed printing press, whereby the modified command rotational speed of the offset sheet-fed printing press is computed and stored into the memory M13. Then, in Step P70, the modified command rotational speed of the offset sheet-fed printing press obtained by computation is written into the memory M3 for the command rotational speed of the offset sheet-fed printing press. Then, the program shifts to Step P75.

If the answer is NO in the above Step P67, the rotational speed modification value during speed reduction is loaded in Step P71 from the memory M12 for the rotational speed modification value during speed reduction. Then, in Step P72, the loaded rotational speed modification value during speed reduction is subtracted from the previous command rotational speed of the offset sheet-fed printing press, whereby the modified command rotational speed of the offset sheet-fed printing press is computed and stored into the memory M13. Then, in Step P73, it is determined whether the modified command rotational speed of the offset sheet-fed printing press is less than 0. If the answer is YES, the modified command rotational speed of the offset sheet-fed printing press is rewritten as zero in Step P74. Then, the program shifts to the aforementioned Step P70. If the answer is NO, the program directly shifts to Step P70.

Then, in Step P75, the time interval for transmitting the command rotational speed of the offset sheet-fed printing press and the virtual current position of the rotary screen cylinder to the drive control device 80 for the rotary screen cylinder are loaded from the memory M5 for the time interval for transmitting the command rotational speed of the offset sheet-fed printing press and the virtual current position of the rotary screen cylinder to the drive control device for the rotary screen cylinder. In Step P76, the count value of the internal clock counter 61 is loaded.

Then, in Step P77, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, in Step P78 the count value is loaded from the counter 75 for detecting the motor shaft position of the offset sheet-fed printing press, and is stored into the memory M6. If the answer is NO, the program returns to Step P76. Then, in Step P79, the current position of the motor shaft of the offset sheet-fed printing press is computed from the count value of the counter 75 for detecting the motor shaft position of the offset sheet-fed printing press, and is stored into the memory M7. In Step P80, the correction value of the current position of the rotary screen cylinder is loaded from the memory M8 for the correction value of the current position of the rotary screen cylinder.

Then, in Step P81, the loaded correction value of the current position of the rotary screen cylinder is added to the current position of the motor shaft of the offset sheet-fed printing press obtained by computation, whereby the virtual current position of the motor shaft of the rotary screen cylinder is computed and stored into the memory M9. Then, in Step P82, the command rotational speed of the offset sheet-fed printing press is loaded from the memory M3 for the command rotational speed of the offset sheet-fed printing press. Then, in Step P83, the command rotational speed of the offset sheet-fed printing press and the virtual current position of the motor shaft of the rotary screen cylinder are transmitted to the drive control device 80 for the rotary screen cylinder. Subsequently, in Step P84, the command rotational speed is outputted to the prime motor driver 67 for the offset sheet-fed printing press.

Then, in Step P8S, the command rotational speed of the offset sheet-fed printing press is written into the memory M10 for the previous command rotational speed of the offset sheet-fed printing press. Then, in Step P86, it is determined whether the stop switch for the printing press is ON. If the answer is YES, the program shifts to Step P87. If the answer is NO, the program returns to Step P60.

Then, in the aforementioned Step P87, zero is written into the memory M2 for the set rotational speed of the offset sheet-fed printing press. Then, in Step P88, counting of the internal clock counter (counting of the elapsed time) 61 is started, whereupon in Step P89 the previous command rotational speed is loaded from the memory M10 for the previous command rotational speed of the offset sheet-fed printing press. Then, in Step P90, it is determined whether the loaded previous command rotational speed of the offset sheet-fed printing press is zero. If the answer is YES, in Step P91 zero is written into the memory M3 for the command rotational speed of the offset sheet-fed printing press. Thereafter, the program shifts to Step P98 to be described later. If NO, in Step P92, the rotational speed modification value during speed reduction is loaded from the memory M12 for the rotational speed modification value during speed reduction.

Then, in Step P93, the loaded rotational speed modification value during speed reduction is subtracted from the previous command rotational speed of the offset sheet-fed printing press, whereby the modified command rotational speed of the offset sheet-fed printing press is computed and stored into the memory M13. Then, in Step P94, it is determined whether the modified command rotational speed of the offset sheet-fed printing press is less than 0. If the answer is YES, the modified command rotational speed of the offset sheet-fed printing press is rewritten as zero in Step P95. Then, in Step P96, the modified command rotational speed of the offset sheet-fed printing press obtained by computation is written into the memory M3 for the command rotational speed of the offset sheet-fed printing press. If the answer is NO, the program directly shifts to Step P96. Then, in Step P97, the modified command rotational speed obtained by computation is written into the memory M10 for the previous command rotational speed of the offset sheet-fed printing press.

Then, in the aforementioned Step P98, the time interval for transmitting the command rotational speed of the offset sheet-fed printing press and the virtual current position of the rotary screen cylinder to the drive control device 80 for the rotary screen cylinder are loaded from the memory MS for the time interval for transmitting the command rotational speed of the offset sheet-fed printing press and the virtual current position of the rotary screen cylinder to the drive control device for the rotary screen cylinder. In Step P99, the count value of the internal clock counter 61 is loaded. Then, in Step P100, it is determined whether the count value of the internal clock counter 61 is equal to or greater than the time interval for transmitting the command rotational speed of the offset sheet-fed printing press and the virtual current position of the rotary screen cylinder to the drive control device for the rotary screen cylinder. If the answer is YES, the count value is loaded in Step P101 from the counter 75 for detecting the motor shaft position of the offset sheet-fed printing press, and is stored into the memory M6. If the answer is NO, the program returns to Step P99.

Then, in Step P102, the current position of the motor shaft of the offset sheet-fed printing press is computed from the count value of the counter 75 for detecting the motor shaft position of the offset sheet-fed printing press, and is stored into the memory M7. Subsequently, in Step P103, the correction value of the current position of the rotary screen cylinder is loaded from the memory M8 for the correction value of the current position of the rotary screen cylinder. Then, in Step P104, the loaded correction value of the current position of the rotary screen cylinder is added to the current position of the motor shaft of the offset sheet-fed printing press obtained by computation, whereby the virtual current position of the motor shaft of the rotary screen cylinder is computed and stored into the memory M9. Then, in Step P105, the command rotational speed of the offset sheet-fed printing press is loaded from the memory M3 for the command rotational speed of the offset sheet-fed printing press.

Then, in Step P106, the command rotational speed of the offset sheet-fed printing press and the virtual current position of the motor shaft of the rotary screen cylinder are transmitted to the drive control device 80 for the rotary screen cylinder. Subsequently, in Step P107, the command rotational speed is outputted to the prime motor driver 67 for the offset sheet-fed printing press. Then, in Step P108, the outputs of the F/V converters 70 and 73 connected to the rotary encoder 71 for the prime motor for the offset sheet-fed printing press and the rotary encoder 74 for the drive motor for the rotary screen cylinder are loaded. Then, in Step P109, the current rotational speeds of the offset sheet-fed printing press and the rotary screen cylinder are computed from the loaded outputs of the F/V converters 70 and 73 connected to the rotary encoders 71 and 74 for the prime motor for the offset sheet-fed printing press and the drive motor for the rotary screen cylinder, and are stored into the memories M14 and M15, respectively.

Then, in Step P110, it is determined whether the current rotational speeds of the offset sheet-fed printing press and the rotary screen cylinder obtained by computation are zero. If the answer is YES, in Step P111 a synchronous operation stop command is transmitted to the drive control device 80 for the rotary screen cylinder. If the answer is NO, the programs returns to Step P88. Then, if in Step P112 asynchronous operation stop signal is transmitted from the drive control device 80 for the rotary screen cylinder, the synchronous operation stop signal is received from the drive control device 80 for the rotary screen cylinder in Step P113.

Then, in Step P114, the start signal for the prime motor driver 67 for the offset sheet-fed printing press is turned off, whereafter a work signal is outputted to the circuit 76 for the prime motor brake on the offset sheet-fed printing press in Step P115. Then, in Step P116, it is determined whether the synchronous operation switch is OFF. If the answer is YES, the program returns to Step P1. If the answer is NO, it is determined in Step P117 whether an offset sheet-fed printing press drive switch is ON. If the answer is YES, the program returns to Step P3. If the answer is NO, the program returns to Step P116. In accordance with the above-mentioned steps, the drive control device 50 for the offset sheet-fed printing press controls the prime motor 68 for the offset sheet-fed printing press and the drive motor 98 for the rotary screen cylinder to be operated in synchronization.

Then, in the aforementioned Step P118, it is determined whether the set rotational speed has been inputted into the rotational speed setting instrument 65. If the answer is YES, the set rotational speed is loaded from the rotational speed setting instrument 65, and stored into the memory M2, in Step P119. Then, the program shifts to Step P120. If the answer is NO, the program directly shifts to Step P120.

Then, in Step P120, it is determined whether the drive switch for the offset sheet-fed printing press is ON. If the answer is YES, in Step P121 a work release signal is outputted to the circuit 76 for the prime motor brake on the offset sheet-fed printing press. If the answer is NO, the program returns to Step P1. Then, in Step P122, a start signal for the prime motor driver 67 for the offset sheet-fed printing press is turned on, whereupon in Step P123 the set rotational speed of the offset sheet-fed printing press is written into the memory M3 for the command rotational speed of the offset sheet-fed printing press.

Then, in Step P124, the command rotational speed of the offset sheet-fed printing press is loaded from the memory M3 for the command rotational speed of the offset sheet-fed printing press. Then, in Step 125, the command rotational speed is outputted to the prime motor driver 67 for the offset sheet-fed printing press. Then, if the stop switch for the printing press is turned on in Step P126, a stop command is outputted to the prime motor driver 67 for the offset sheet-fed printing press in Step P127. Then, in Step P128, the start signal for the prime motor driver 67 for the offset sheet-fed printing press is turned off. Then, in Step P129, a work signal is outputted to the circuit 76 for the prime motor brake on the offset sheet-fed printing press, whereafter the program returns to Step P1. In accordance with the above-described steps, the drive control device 50 for the offset sheet-fed printing press controls the prime motor 68 for the offset sheet-fed printing press to be driven alone.

Next, the drive control device 80 for the rotary screen cylinder acts in accordance with the motion flows shown in FIGS. 12(a) and 12(b), FIGS. 13(a) and 13(b), and FIG. 14.

In Step P1, it is determined whether a home position alignment make-ready start command has been transmitted from the drive control device 50 for the offset sheet-fed printing press. If the answer is NO, the program shifts to Step P61 to be described later. If the answer is YES, in Step P2 the home position alignment make-ready start command is received from the drive control device 50 for the offset sheet-fed printing press. Then, in Step P3, a start signal for the drive motor driver 97 for the rotary screen cylinder is turned on. If in Step P4 a command (slower) rotational speed is transmitted from the drive control device 50 for the offset sheet-fed printing press, in Step P5 the command (slower) rotational speed is received from the drive control device 50 for the offset sheet-fed printing press, and stored into the memory M1.

Then, in Step P6, the command (slower) rotational speed of the offset sheet-fed printing press is loaded from the memory M1 for the command rotational speed of the offset sheet-fed printing press. Afterwards, in Step P7, the command (slower) rotational speed of the offset sheet-fed printing press is written into the memory M2 for the command rotational speed of the rotary screen cylinder. Then, in Step P8, the command rotational speed is outputted to the drive motor driver 97 for the rotary screen cylinder. If, in Step P9, a home position alignment ready command is transmitted from the drive control device 50 for the offset sheet-fed printing press, the home position alignment ready command is received from the drive control device 50 for the offset sheet-fed printing press in Step P10. Then, if in Step P11 a home position alignment start command is transmitted from the drive control device 50 for the offset sheet-fed printing press, the home position alignment start command is received from the drive control device 50 for the offset sheet-fed printing press in Step P12.

Then, if in Step P13 the command (slower) rotational speed of the offset sheet-fed printing press and the virtual current position of the motor shaft of the rotary screen cylinder are transmitted from the drive control device 50 for the offset sheet-fed printing press, the command (slower) rotational speed of the offset sheet-fed printing press and the virtual current position of the motor shaft of the rotary screen cylinder are received from the drive control device 50 for the offset sheet-fed printing press, and stored into the memory M1 and the memory M3, in Step P14. Then, in Step P15, the count value is loaded from the counter 101 for detecting the motor shaft position of the rotary screen cylinder, and stored into the memory M4. Subsequently, in Step P16, the current position of the motor shaft of the rotary screen cylinder is computed from the loaded count value of the counter 101 for detecting the motor shaft position of the rotary screen cylinder, and is stored into the memory M5.

Then, in Step P17, the difference in the current position of the motor shaft is computed from the above-mentioned received virtual current position of the motor shaft of the rotary screen cylinder and the computed current position of the motor shaft of the rotary screen cylinder, and stored into the memory MG. Subsequently, in Step P18, the absolute value of the difference in the current position of the motor shaft is computed from the above computed difference in the current position of the motor shaft, and stored into the memory M7. Then, in Step P19, the allowable value of the difference in the position of the motor shaft is loaded from the memory M8 for the allowable value of the difference in the position of the motor shaft. Upon its loading, it is determined in Step P20 whether the above-mentioned computed absolute value of the difference in the current position of the motor shaft is equal to or less than the allowable value of the difference in the position of the motor shaft.

If the answer is YES in Step P20, the command (slower) rotational speed of the offset sheet-fed printing press is loaded from the memory M1 for the command rotational speed of the offset sheet-fed printing press in Step P21. Upon its loading, the command (slower) rotational speed of the offset sheet-fed printing press is written into the memory M2 for the command rotational speed of the rotary screen cylinder in Step P22. Then, in Step P23, the command rotational speed is outputted to the drive motor driver 97 for the rotary screen cylinder. Then, in Step P24, a signal for completion of home position alignment of the motor shaft is transmitted to the drive control device 50 for the offset sheet-fed printing press. Then, the program shifts to Step P31 to be described later.

If the answer is NO in Step P20, the table for conversion between the difference in the current position of the motor shaft and the correction value of the command rotational speed (i.e., difference in current position of motor shaft-correction value of command rotational speed conversion table) is loaded in Step P25 from the memory M9 for the difference in current position of motor shaft-correction value of command rotational speed conversion table. Upon this loading, the difference in the current position of the motor shaft is loaded from the memory M6 for the difference in the current position of the motor shaft in Step P26. Then, in Step P27, the correction value of the command rotational speed of the rotary screen cylinder is obtained based on the difference in the current position of the motor shaft with the use of the difference in current position of motor shaft-correction value of command rotational speed conversion table, and is stored into the memory M10. Subsequently, in Step P28, the command (slower) rotational speed is loaded from the memory M1 for the command rotational speed of the offset sheet-fed printing press.

Then, in Step P29, the obtained correction value of the command rotational speed of the rotary screen cylinder is added to the loaded command (slower) rotational speed of the offset sheet-fed printing press, whereby the command rotational speed of the rotary screen cylinder is computed and stored into the memory M2. In Step P30, the command rotational speed is outputted to the drive motor driver 97 for the rotary screen cylinder. Then, the program returns to the aforementioned Step P13. In accordance with the above-described steps, the home position alignment of the drive motor 98 for the rotary screen cylinder with respect to the prime motor 68 for the offset sheet-fed printing press is carried out.

In the aforementioned Step P31, it is determined whether the command rotational speed of the offset sheet-fed printing press and the virtual current position of the motor shaft of the rotary screen cylinder have been transmitted from the drive control device 50 for the offset sheet-fed printing press. If the answer is NO, it is determined in Step P48 whether a synchronous operation stop command has been transmitted from the drive control device 50 for the offset sheet-fed printing press.

If the answer is YES in Step P31, the command rotational speed of the offset sheet-fed printing press and the virtual current position of the motor shaft of the rotary screen cylinder are received from the drive control device 50 for the offset sheet-fed printing press, and stored into the memory M1 and the memory M3, in Step P32. Then, in Step P33, the count value is loaded from the counter 101 for detecting the motor shaft position of the rotary screen cylinder, and stored into the memory M4. In Step P34, the current position of the motor shaft of the rotary screen cylinder is computed from the loaded count value of the counter 101 for detecting the motor shaft position of the rotary screen cylinder, and is stored into the memory M5.

Then, in Step P35, the difference in the current position of the motor shaft is computed from the above-mentioned received virtual current position of the motor shaft of the rotary screen cylinder and the computed current position of the motor shaft of the rotary screen cylinder, and stored into the memory M6. Subsequently, in Step P36, the absolute value of the difference in the current position of the motor shaft is computed from the above computed difference in the current position of the motor shaft, and stored into the memory M7. Then, in Step P37, the allowable value of the difference in the position of the motor shaft is loaded from the memory M8 for the allowable value of the difference in the position of the motor shaft. Upon its loading, it is determined in Step P38 whether the above-mentioned computed absolute value of the difference in the current position of the motor shaft is equal to or less than the loaded allowable value of the difference in the position of the motor shaft.

If the answer is YES in Step P38, the command rotational speed of the offset sheet-fed printing press is loaded from the memory M1 for the command rotational speed of the offset sheet-fed printing press in Step P39. Upon its loading, the command rotational speed of the offset sheet-fed printing press is written into the memory M2 for the command rotational speed of the rotary screen cylinder in Step P40. Then, in Step P41, the command rotational speed is outputted to the drive motor driver 97 for the rotary screen cylinder. Then, the program returns to Step P31.

If the answer is NO in Step P38, the difference in current position of motor shaft-correction value of command rotational speed conversion table is loaded in Step P42 from the memory M9 for the difference in current position of motor shaft-correction value of command rotational speed conversion table. Upon this loading, the difference in the current position of the motor shaft is loaded from the memory M6 for the difference in the current position of the motor shaft in Step P43. Then, in Step P44, the correction value of the command rotational speed of the rotary screen cylinder is obtained based on the difference in the current position of the motor shaft with the use of the difference in current position of motor shaft-correction value of command rotational speed conversion table, and is stored into the memory M10. Subsequently, in Step P45, the command rotational speed of the offset sheet-fed printing press is loaded from the memory M1 for the command rotational speed of the offset sheet-fed printing press.

Then, in Step P46, the obtained correction value of the command rotational speed of the rotary screen cylinder is added to the loaded command rotational speed of the offset sheet-fed printing press, whereby the command rotational speed of the rotary screen cylinder is computed and stored into the memory M2. In Step P47, the command rotational speed is outputted to the drive motor driver 97 for the rotary screen cylinder. Then, the program returns to Step P31.

If the answer is NO in Step P48, the program returns to Step P31. If the answer is YES in Step P48, on the other hand, a synchronous operation stop command is received from the drive control device 50 for the offset sheet-fed printing press in Step P49. Then, in Step P50, a synchronous operation stop signal is transmitted to the drive control device 50 for the offset sheet-fed printing press. Then, in Step P51, the slower rotational speed is loaded from the memory M11 for the slower rotational speed.

Then, in Step P52, the slower rotational speed is written into the memory M2 for the command rotational speed of the rotary screen cylinder, whereafter in Step P53 the command rotational speed is outputted to the drive motor driver 97 for the rotary screen cylinder. Then, in Step P54, the count value is loaded from the counter 101 for detecting the motor shaft position of the rotary screen cylinder, and stored into the memory M4. Then, in Step P55, the current position of the motor shaft is computed from the loaded count value of the counter 101 for detecting the motor shaft position of the rotary screen cylinder, and stored into the memory M5.

Then, in Step P56, the stop position of the rotary screen cylinder is loaded from the memory M12 for the stop position of the rotary screen cylinder. Then, in Step P57, it is determined whether the current position of the motor shaft equals the stop position of the rotary screen cylinder. If the answer is YES, a stop command is outputted to the drive motor driver 97 for the rotary screen cylinder in Step P58. If the answer is NO, the program returns to Step P54. Then, in Step P59, the start signal for the drive motor driver 97 for the rotary screen cylinder is turned off, whereupon a work signal is outputted to the circuit 78 for the drive motor brake on the rotary screen cylinder in Step P60. Then, the program returns to Step P1. In accordance with the above-described steps, the drive control device 80 for the rotary screen cylinder controls the drive motor 98 for the rotary screen cylinder to be synchronized with the prime motor 68 for the offset sheet-fed printing press, and controls the rotary screen cylinder to stop at a position where the hole-free portion A of the rotary screen 202 comes to the lowermost position.

Then, in the aforementioned Step P61, it is determined whether the set rotational speed has been inputted to the rotational speed setting instrument 95 for the rotary screen cylinder. If the answer is YES, the set rotational speed is loaded from the rotational speed setting instrument 95 for the rotary screen cylinder, and stored into the memory M13, in Step P62. Then, the program shifts to Step P63. If the answer is NO, the program directly shifts to Step P63.

In Step P63, it is determined whether an individual drive switch for the rotary screen cylinder is ON. If the answer is YES, a work release signal is outputted to the circuit 78 for the drive motor brake on the rotary screen cylinder in Step P64. If the answer is NO, the program returns to Step P1. Then, in Step P65, a start signal for the drive motor driver 97 for the rotary screen cylinder is turned on, whereupon the set rotational speed of the rotary screen cylinder is written into the memory M2 for the command rotational speed of the rotary screen cylinder in Step P66.

Then, in Step P67, the command rotational speed of the rotary screen cylinder is loaded from the memory M2 for the command rotational speed of the rotary screen cylinder. Then, in Step P68, the command rotational speed is outputted to the drive motor driver 97 for the rotary screen cylinder. If the stop switch for the rotary screen cylinder is turned on in Step P69, the slower rotational speed is loaded from the memory M11 for the slower rotational speed in Step P70. Then, in Step P71, the slower rotational speed is written into the memory M2 for the command rotational speed of the rotary screen cylinder.

Then, in Step P72, the command rotational speed is outputted to the drive motor driver 97 for the rotary screen cylinder. Then, in Step P73, the count value is loaded from the counter 101 for detecting the motor shaft position of the rotary screen cylinder, and stored into the memory M4. Then, in Step P74, the current position of the motor shaft is computed from the loaded count value of the counter 101 for detecting the motor shaft position of the rotary screen cylinder, and stored into the memory M5. Then, in Step P75, the stop position of the rotary screen cylinder is loaded from the memory M12 for the stop position of the rotary screen cylinder.

Then, in Step P76, it is determined whether the current position of the motor shaft equals the stop position of the rotary screen cylinder. If the answer is YES, a stop command is outputted to the drive motor driver 97 for the rotary screen cylinder in Step P77. If the answer is NO, the program returns to Step P73. Then, in Step P78, the start signal for the drive motor driver 97 for the rotary screen cylinder is turned off, whereupon a work signal is outputted to the circuit 78 for the drive motor brake on the rotary screen cylinder in Step P79. Then, the program returns to Step P1. Subsequently, this procedure is repeated. In accordance with the above-described steps, the drive control device 80 for the rotary screen cylinder controls the drive motor 98 for the rotary screen cylinder to be individually driven, and controls the rotary screen cylinder to stop at the position where the hole-free portion A of the rotary screen 202 comes to the lowermost position.

According to the present embodiment, as described above, the drive control device 50 for the offset sheet-fed printing press and the drive control device 80 for the rotary screen cylinder start speed reduction of the rotational speed of the prime motor 68 under the stop command. When the rotational speed detected by the rotary encoder 71 comes to zero, synchronous control of the drive motor 98 for the rotary screen cylinder is released. Then, the drive motor 98 for the rotary screen cylinder is controlled such that the rotary screen cylinder of the rotary screen device 200 is stopped at the position where the pattern-free portion (hole-free portion) A in the screen 202 comes to the lowermost position (see FIG. 5)

As noted above, the rotary screen cylinder is stopped at the position where the pattern-free portion (hole-free portion) A in the screen 202 comes to the lowermost position. Thus, ink does not fall from the pattern-free portion (hole-free portion) A.

Accordingly, the degree of freedom increases in the type of ink that can be used, and the size of the hole. The diversification of printing products can be achieved. At a standstill of printing, the rotary screen cylinder can also be stopped. Thus, the electric power consumption of the drive motor 98 for the rotary screen cylinder and the drive motor driver 97 for the rotary screen cylinder can be decreased, and the durability of the motor and the motor shaft bearing portion can be enhanced.

### Embodiment 2

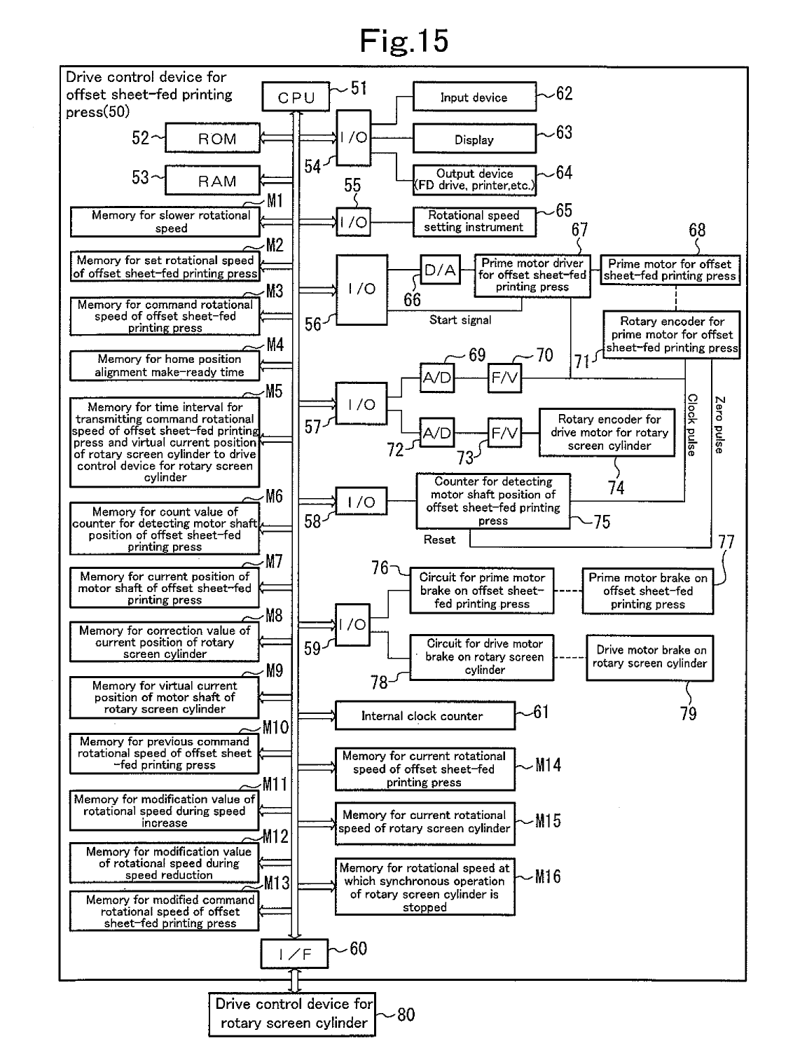

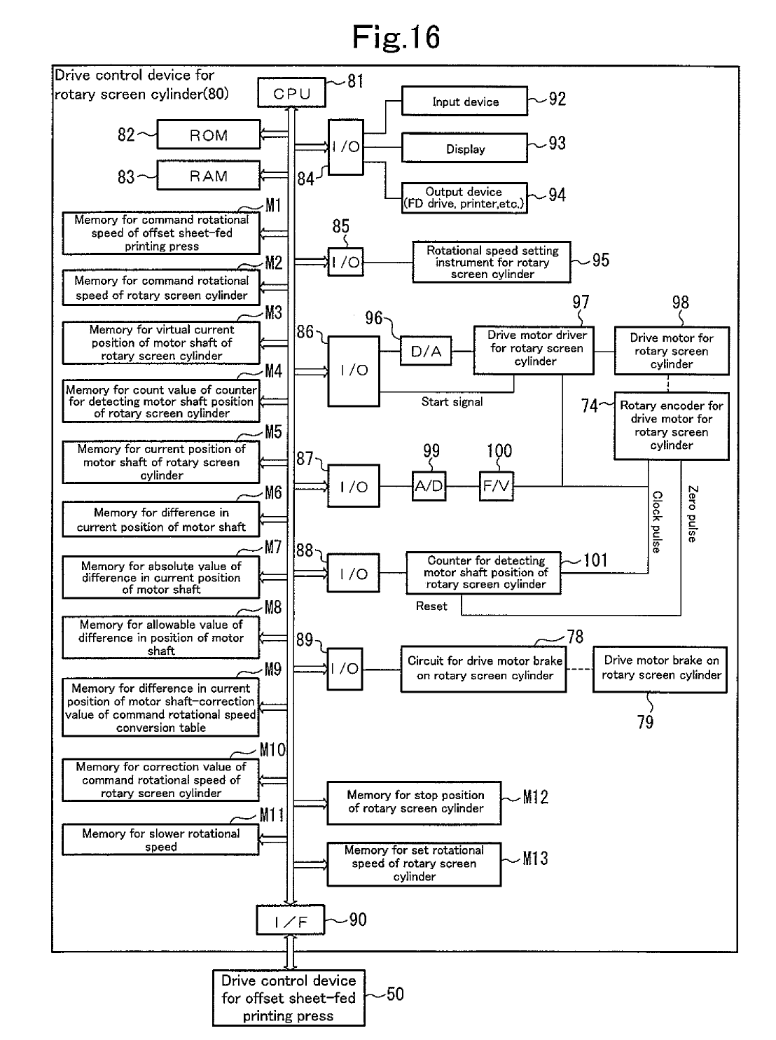

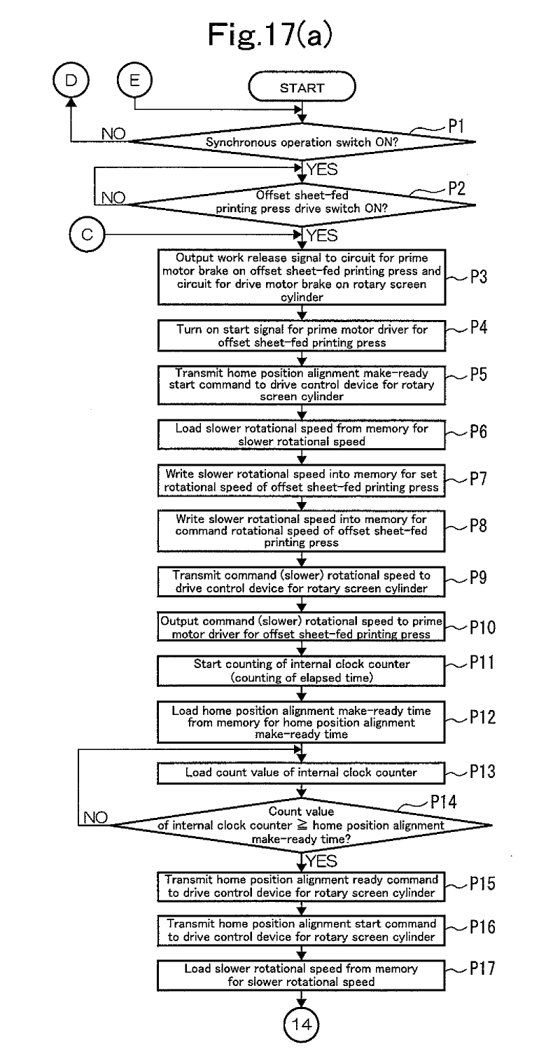

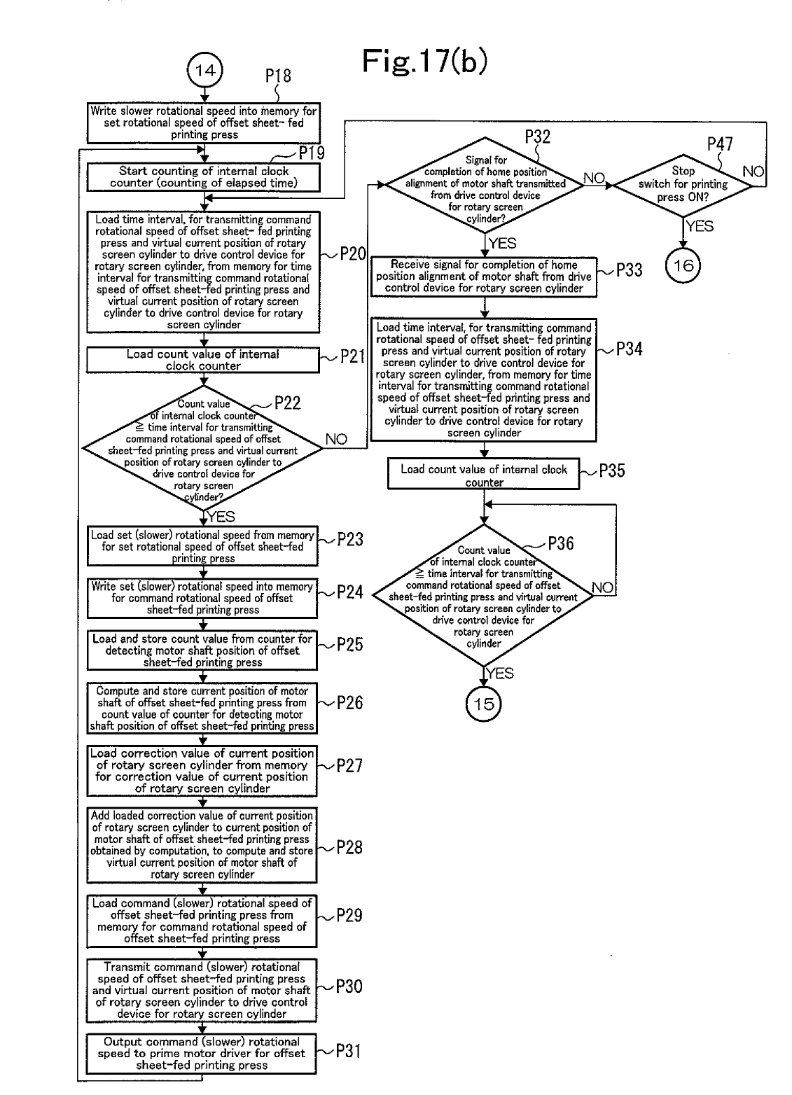

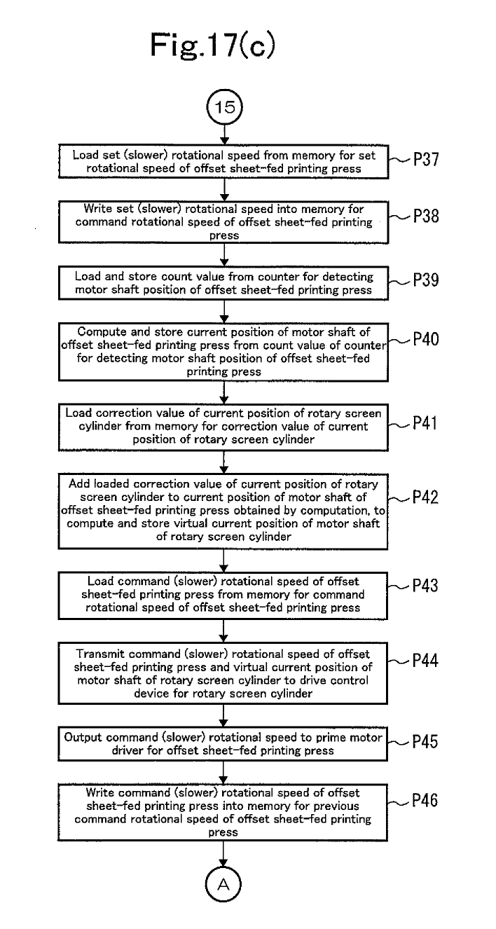

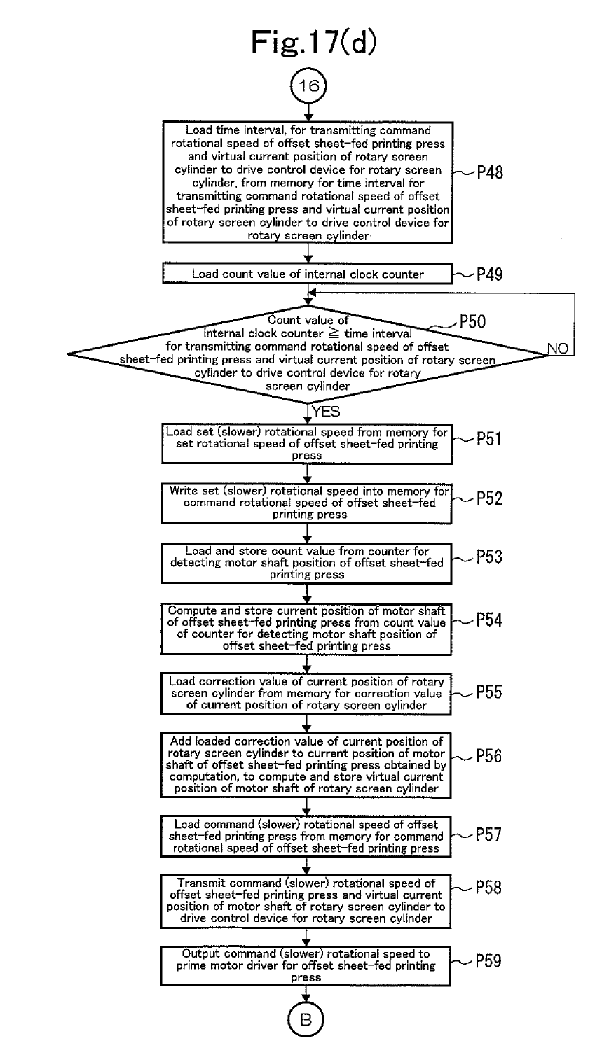

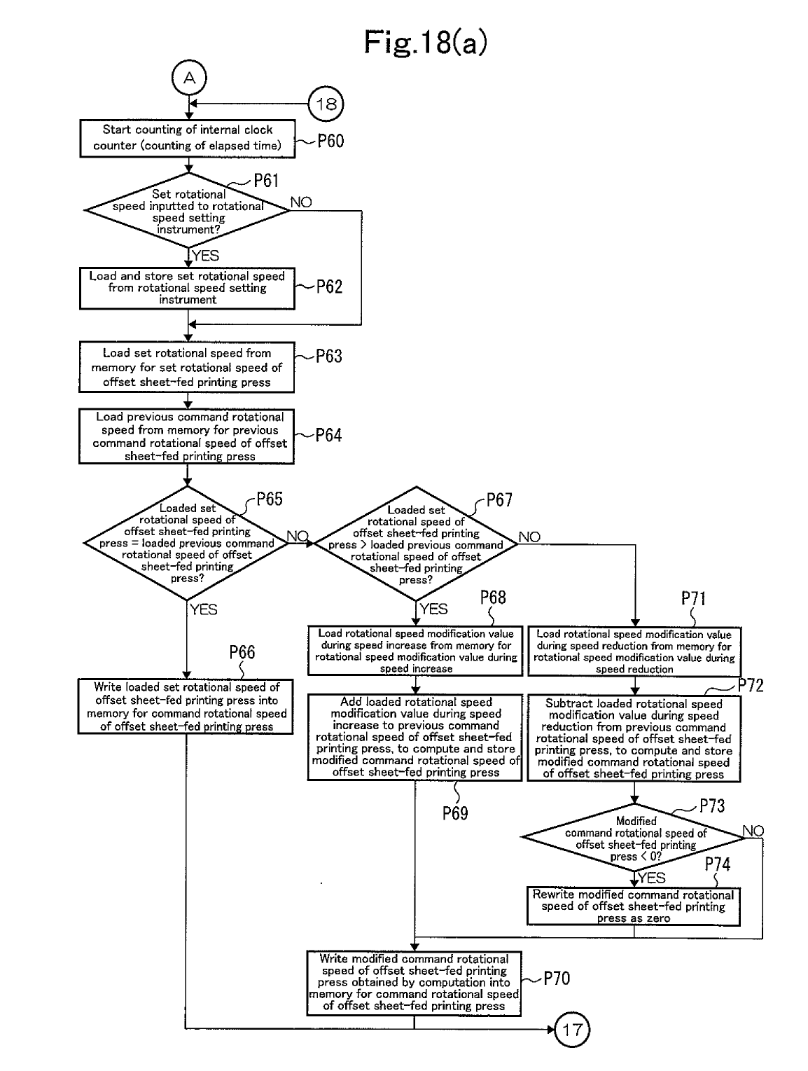

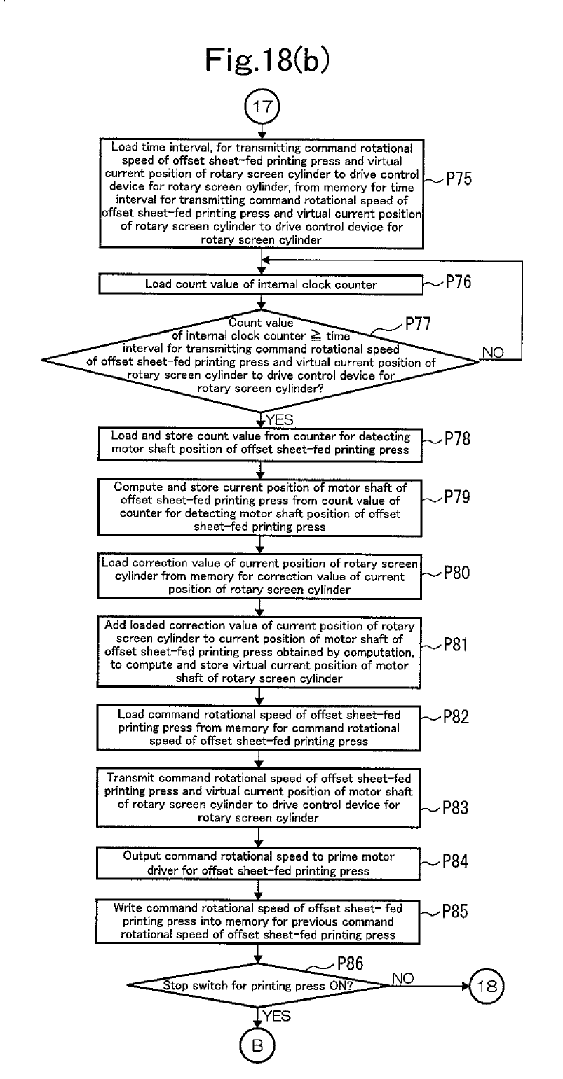

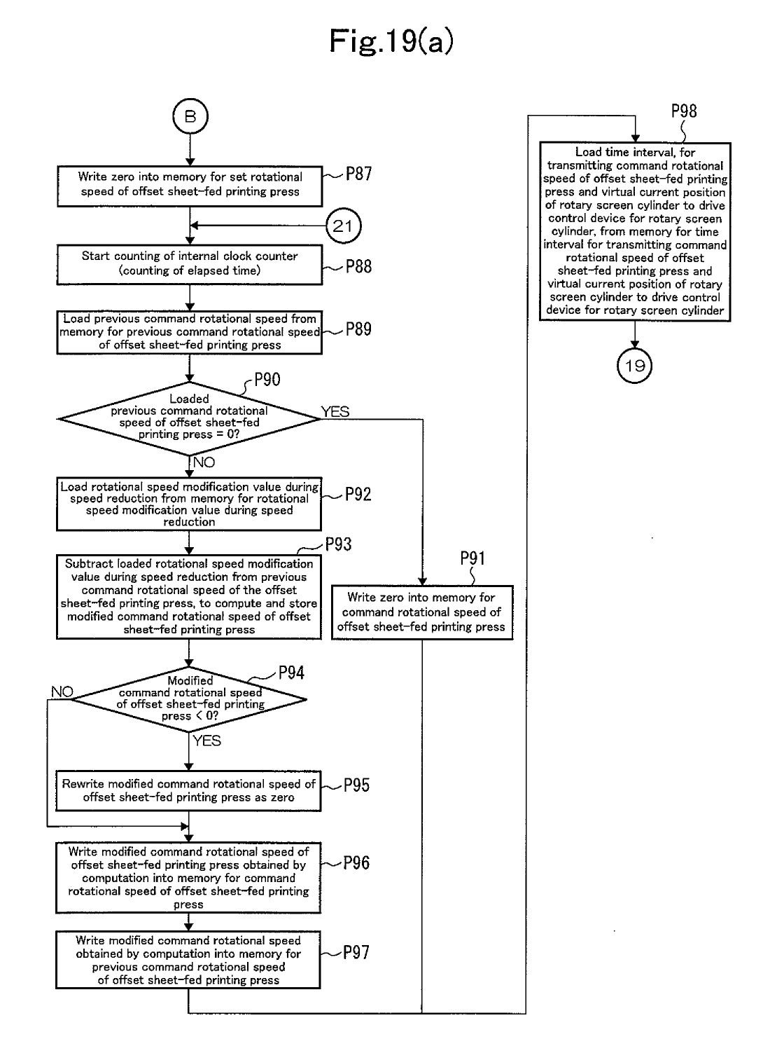

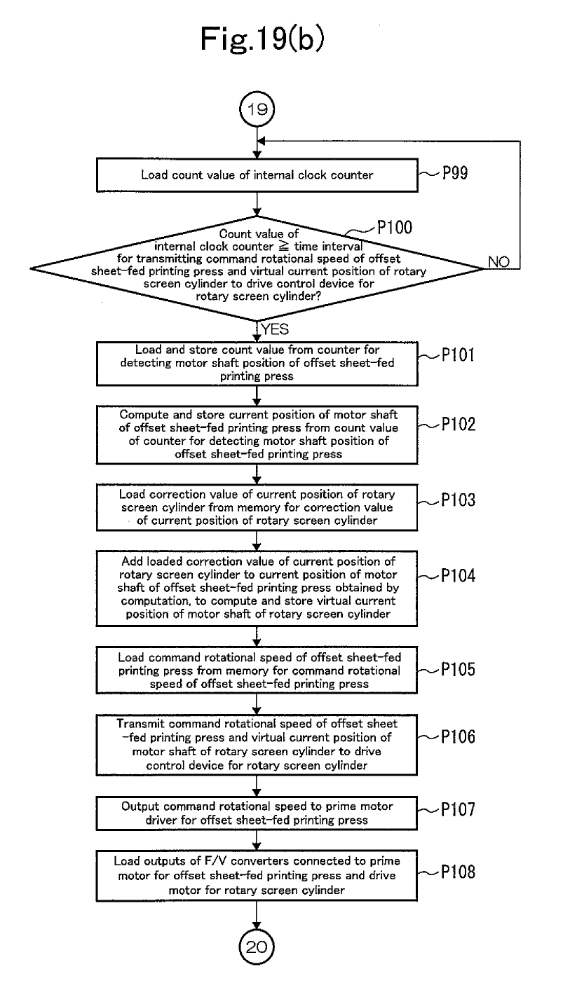

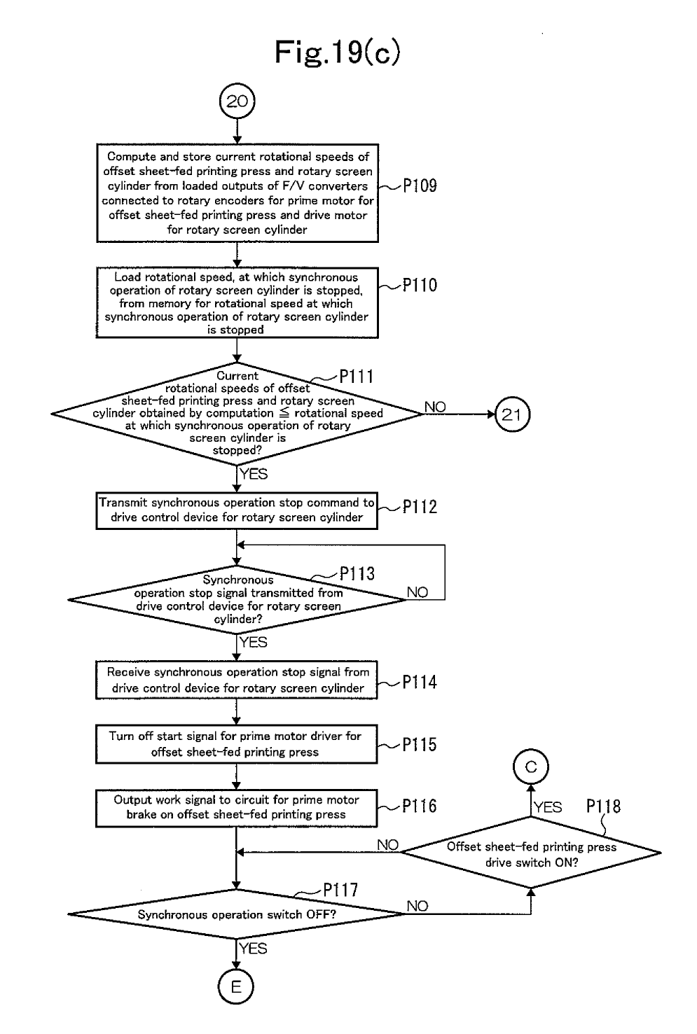

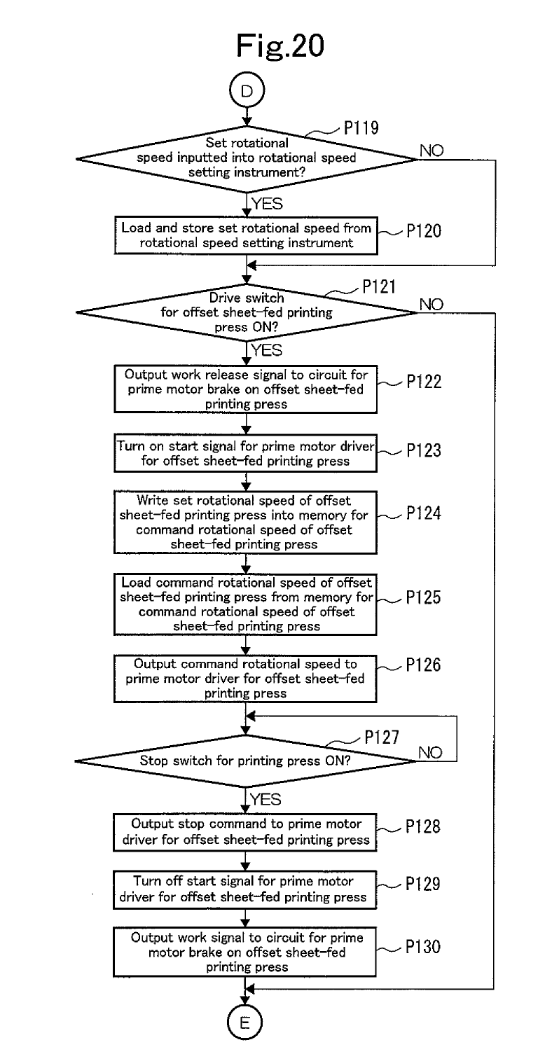

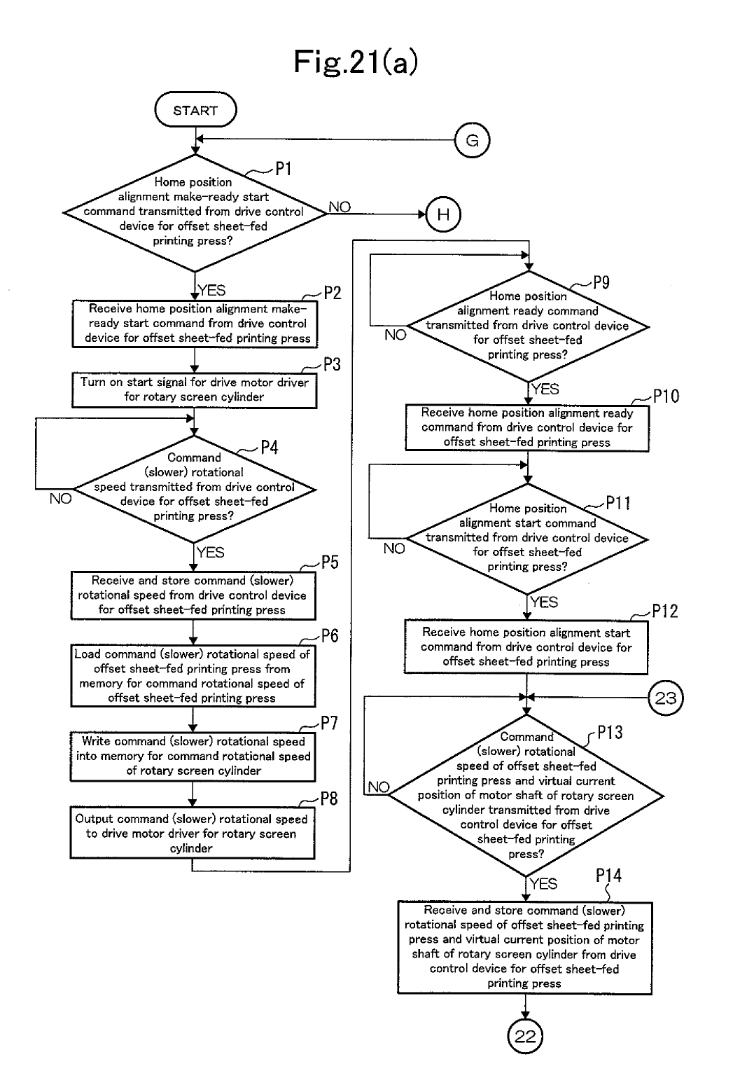

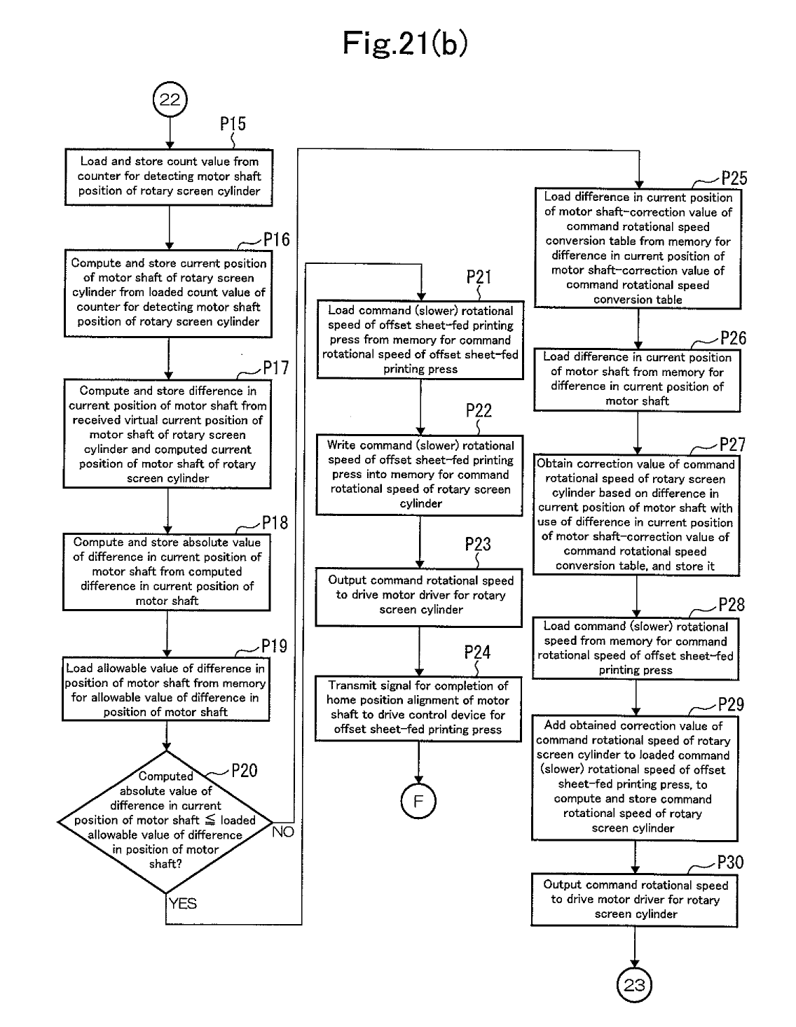

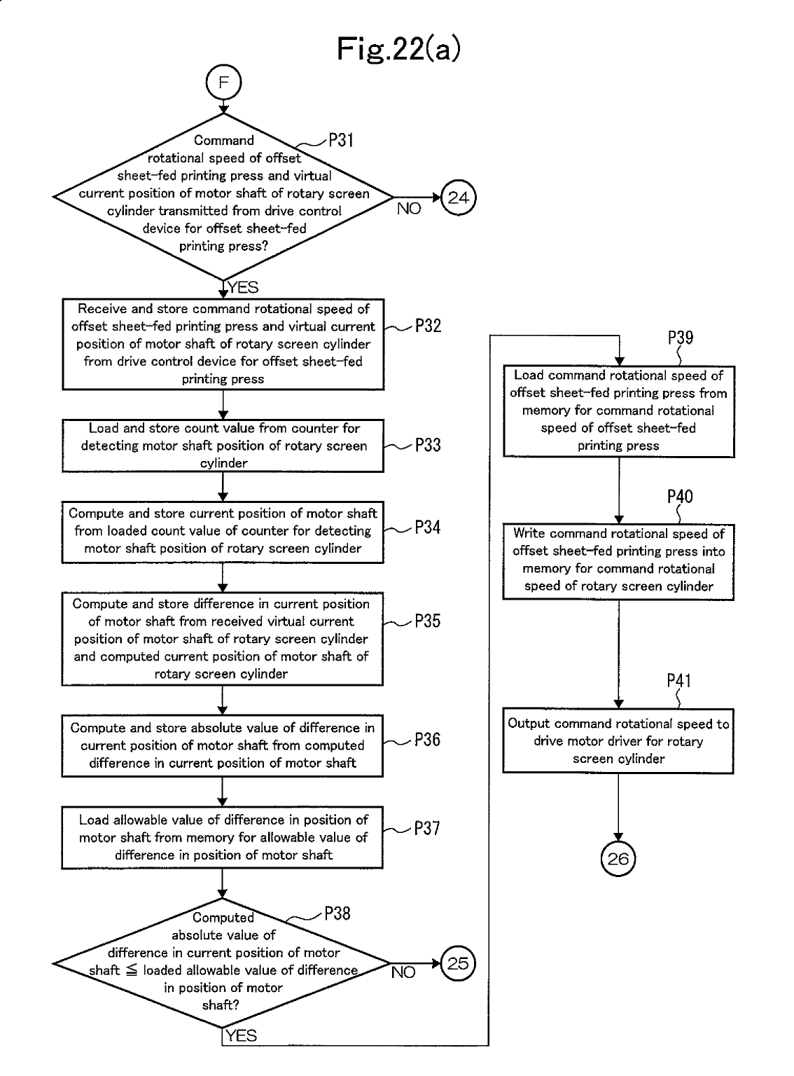

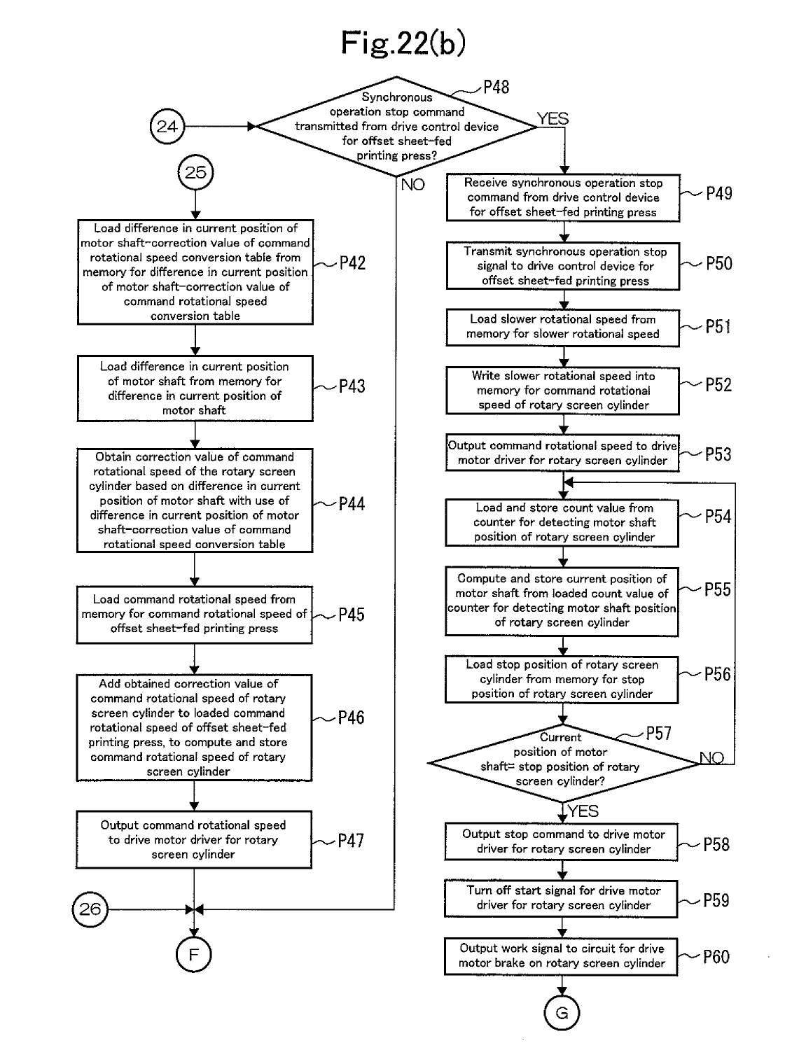

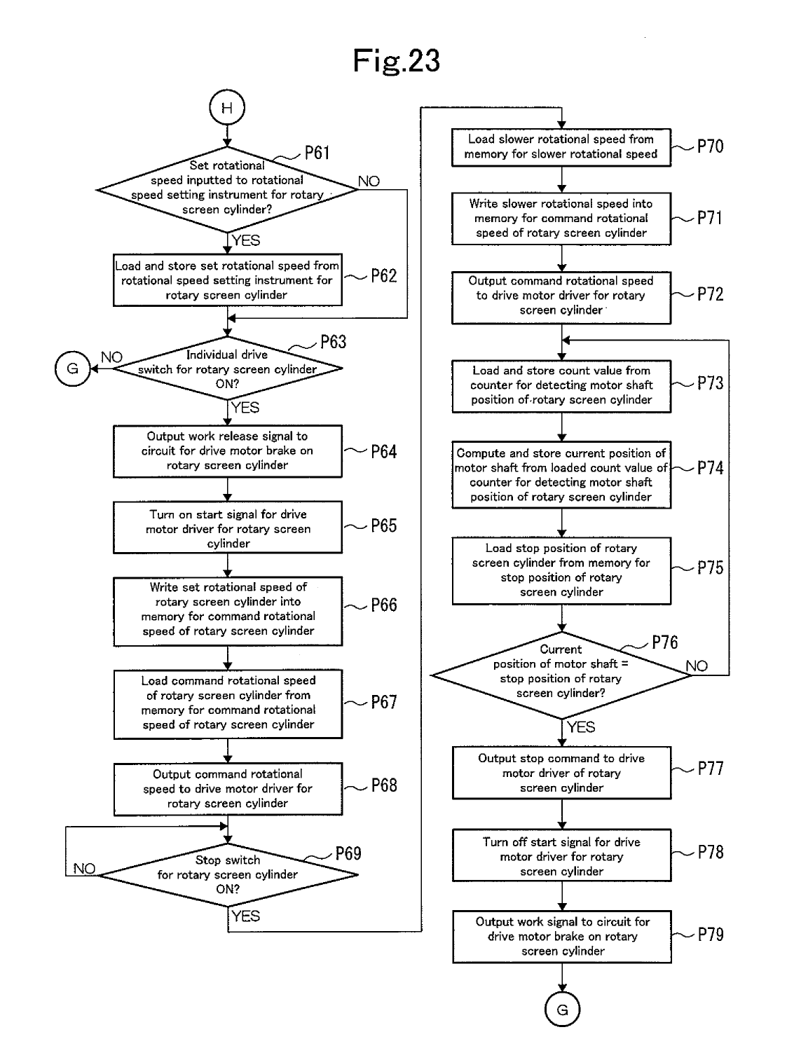

FIG. 15 is a block diagram of a drive control device for an offset sheet-fed printing press showing Embodiment 2 of the present invention. FIG. 16 is a block diagram of a drive control device for a rotary screen cylinder. FIGS. 17(a) to 17(d) are motion flow charts of the drive control device for the offset sheet-fed printing press. FIGS. 18(a) and 18(b) are motion flow charts of the drive control device for the offset sheet-fed printing press. FIGS. 19(a) to 19(c) are motion flow charts of the drive control device for the offset sheet-fed printing press. FIG. 20 is a motion flow chart of the drive control device for the offset sheet-fed printing press. FIGS. 21(a) and 21(b) are motion flow charts of the drive control device for the rotary screen cylinder. FIGS. 22(a) and 22(b) are motion flow charts of the drive control device for the rotary screen cylinder. FIG. 23 is a motion flow chart of the drive control device for the rotary screen cylinder.

The present embodiment is Embodiment 1 modified as follows: The drive control device 50 for the offset sheet-fed printing press and the drive control device 80 for the rotary screen cylinder start the speed reduction of the rotational speed of the prime motor 68 under a stop command. When the rotational speed detected by the rotary encoder is equal to or lower than a predetermined rotational speed which is not zero, synchronous control of the drive motor 98 is released. Then, the drive motor 98 is controlled to stop the rotary screen cylinder of the rotary screen device 200 at such a position that the pattern-free portion (hole-free portion) A in the screen 202 comes to a lowermost position.

As shown in FIG. 15, the drive control device 50 for the offset sheet-fed printing press has a CPU 51, an ROM 502, an RAM 53, input/output devices 54 to 59, and an interface 60 connected by a BUS line.

To the BUS line, the following memories are connected in addition to an internal clock counter 61: A memory M1 for a slower rotational speed; a memory M2 for the set rotational speed of the offset sheet-fed printing press; a memory M3 for the command rotational speed of the offset sheet-fed printing press; a memory M4 for a home position alignment make-ready time; a memory M5 for a time interval for transmitting the command rotational speed of the offset sheet-fed printing press and the virtual current position of the rotary screen cylinder to the drive control device for the rotary screen cylinder; a memory M6 for the count value of a counter for detecting the motor shaft position of the offset sheet-fed printing press; and a memory M7 for the current position of the motor shaft of the offset sheet-fed printing press.

To the BUS line, the following memories are further connected: A memory M8 for the correction value of the current position of the rotary screen cylinder; a memory M9 for the virtual current position of the motor shaft of the rotary screen cylinder; a memory M10 for the previous command rotational speed of the offset sheet-fed printing press; a memory M11 for the modification value of the rotational speed during speed increase; a memory M12 for the modification value of the rotational speed during speed reduction; a memory M13 for the modified command rotational speed of the offset sheet-fed printing press; a memory M14 for the current rotational speed of the offset sheet-fed printing press; a memory M15 for the current rotational speed of the rotary screen cylinder; and a memory M16 for the rotational speed at which the synchronous operation of the rotary screen cylinder is stopped.

To the input/output device 54, there are connected an input device 62 such as a keyboard, various switches and buttons, a display 63 such as a CRT or a lamp, and an output device 64 such as a printer or a floppy disk (registered trademark) drive. A rotational speed setting instrument 65 is connected to the input/output device 55.

To the input/output device 56, a prime motor driver 67 for the offset sheet-fed printing press is connected via a D/A converter 66. A prime motor 68 for the offset sheet-fed printing press, and a rotary encoder 71 for the prime motor for the offset sheet-fed printing press are connected to the prime motor driver 67.

To the input/output device 57, the rotary encoder 71 for the prime motor for the offset sheet-fed printing press is connected via an A/D converter 69 and an F/V converter 70, and a rotary encoder 74 for the drive motor for the rotary screen cylinder is connected via an A/D converter 72 and an F/V converter 73.

To the input/output device 58, a counter 75 for detecting the motor shaft position of the offset sheet-fed printing press is connected. The rotary encoder 71 for the prime motor for the offset sheet-fed printing press is connected to the counter 75.

To the input/output device 59, a prime motor brake 77 on the offset sheet-fed printing press is connected via a circuit 76 for the prime motor brake on the offset sheet-fed printing press, and a drive motor brake 79 on the rotary screen cylinder is connected via a circuit 78 for the drive motor brake on the rotary screen cylinder. The drive control device 80 for the rotary screen cylinder to be described later is connected to the interface 60.

As shown in FIG. 16, the drive control device 80 for the rotary screen cylinder comprises a CPU 81, an ROM 82, an RAM 83, input/output devices 84 to 89, and an interface 90 connected by a BUS line.

To the BUS line, the following memories are connected: A memory M1 for the command rotational speed of the offset sheet-fed printing press; a memory M2 for the command rotational speed of the rotary screen cylinder; a memory M3 for the virtual current position of the motor shaft of the rotary screen cylinder; a memory M4 for the count value of a counter for detecting the motor shaft position of the rotary screen cylinder; a memory M5 for the current position of the motor shaft of the rotary screen cylinder; a memory M6 for a difference in the current position of the motor shaft; and a memory M7 for the absolute value of the difference in the current position of the motor shaft.

To the BUS line, the following memories are further connected: A memory M8 for the allowable value of the difference in the position of the motor shaft; a memory M9 for a conversion table of the difference in the current position of the motor shaft-correction value of the command rotational speed (i.e., difference in current position of motor shaft-correction value of command rotational speed conversion table); a memory M10 for the correction value of the command rotational speed of the rotary screen cylinder; a memory M11 for a slower rotational speed; a memory M12 for the stop position of the rotary screen cylinder; and a memory M13 for the set rotational speed of the rotary screen cylinder. The stop position of the rotary screen cylinder, which is stored in the memory M12 for the stop position of the rotary screen cylinder, is the position where the hole-free portion A of the rotary screen 202 comes to the lowermost position, as shown in FIG. 5.

To the input/output device 84, there are connected an input device 92 such as a keyboard, various switches and buttons, a display 93 such as a CRT or a lamp, and an output device 94 such as a printer or a floppy disk (registered trademark) drive. A rotational speed setting instrument 95 for the rotary screen cylinder is connected to the input/output device 85.

To the input/output device 86, a drive motor driver 97 for the rotary screen cylinder is connected via a D/A converter 96. A drive motor 98 for the rotary screen cylinder and a rotary encoder 74 for the drive motor for the rotary screen cylinder are connected to the drive motor driver 97.

To the input/output device 87, the rotary encoder 74 for the drive motor for the rotary screen cylinder is connected via an A/D converter 99 and an F/V converter 100. To the input/output device 88, a counter 101 for detecting the motor shaft position of the rotary screen cylinder is connected. The rotary encoder 74 for the drive motor for the rotary screen cylinder is connected to the counter 101.

To the input/output device 89, a drive motor brake 79 on the rotary screen cylinder is connected via a circuit 78 for the drive motor brake on the rotary screen cylinder. The aforementioned drive control device 50 for the offset sheet-fed printing press is connected to the interface 90.

Because of the above-described features, in controlling the rotary screen cylinder in synchronization with the offset sheet-fed printing press, the drive control device 50 for the offset sheet-fed printing press acts in accordance with the motion flows shown in FIGS. 17(a) to 17(d), 18(a) and 18(b), 19(a) to 19(c), and 20.

In Step P1, it is determined whether a synchronous operation switch is ON. If ON, it is determined in Step P2 whether an offset sheet-fed printing press drive switch is ON. If not ON in Step P1, the program shifts to Step P119 to be described later. If ON in Step P2, a work release signal is outputted to the circuit 76 for the prime motor brake on the offset sheet-fed printing press and the circuit 78 for the drive motor brake on the rotary screen cylinder in Step P3. Then, in Step P4, a start signal for the prime motor driver 67 for the offset sheet-fed printing press is turned on. Then, in Step P5, a home position alignment make-ready start command is transmitted to the drive control device 80 for the rotary screen cylinder.

Then, in Step P6, a slower rotational speed is loaded from the memory M1 for the slower rotational speed. In Step P7, the slower rotational speed is written into the memory M2 for the set rotational speed of the offset sheet-fed printing press. Then, in Step P8, the slower rotational speed is written into the memory M3 for the command rotational speed of the offset sheet-fed printing press. Then, in Step P9, the command (slower) rotational speed is transmitted to the drive control device 80 for the rotary screen cylinder.

Then, in Step P10, the command (slower) rotational speed is outputted to the prime motor driver 67 for the offset sheet-fed printing press. Then, in Step P11, counting of the internal clock counter (counting of the elapsed time) 61 is started. Then, in Step P12, the home position alignment make-ready time is loaded from the memory M4 for the home position alignment make-ready time. In Step P13, the count value of the internal clock counter 61 is loaded.

If, in Step P14, the count value of the internal clock counter 61 is equal to or greater than the home position alignment make-ready time, a home position alignment ready command is transmitted to the drive control device 80 for the rotary screen cylinder in Step P15. Then, instep P16, a home position alignment start command is transmitted to the drive control device 80 for the rotary screen cylinder. Then, in Step P17, the slower rotational speed is loaded from the memory M1 for the slower rotational speed.

Then, in Step P18, the slower rotational speed is written into the memory M2 for the set rotational speed of the offset sheet-fed printing press. Thereafter, in Step P19, counting of the internal clock counter (counting of the elapsed time) 61 is started. Then, in Step P20, the time interval for transmitting the command rotational speed of the offset sheet-fed printing press and the virtual current position of the rotary screen cylinder to the drive control device 80 for the rotary screen cylinder are loaded from the memory M5 for the time interval for transmitting the command rotational speed of the offset sheet-fed printing press and the virtual current position of the rotary screen cylinder to the drive control device for the rotary screen cylinder. In Step P21, the count value of the internal clock counter 61 is loaded.

Then, in Step P22, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, the set (slower) rotational speed is loaded from the memory M2 for the set rotational speed of the offset sheet-fed printing press in Step P23. Then, in Step P24, the set (slower) rotational speed is written into the memory M3 for the command rotational speed of the offset sheet-fed printing press. Afterwards, in Step P25, the count value is loaded from the counter 75 for detecting the motor shaft position of the offset sheet-fed printing press, and stored into the memory M6.

Then, in Step P26, the current position of the motor shaft of the offset sheet-fed printing press is computed from the count value of the counter 75 for detecting the motor shaft position of the offset sheet-fed printing press, and stored into the memory M7. Then, in Step P27, the correction value of the current position of the rotary screen cylinder is loaded from the memory M8 for the correction value of the current position of the rotary screen cylinder.

Then, in Step P28, the loaded correction value of the current position of the rotary screen cylinder is added to the current position of the motor shaft of the of f set sheet- f ed printing press obtained by the above computation, whereby the virtual current position of the motor shaft of the rotary screen cylinder is computed and stored into the memory M9. Then, in Step P29, the command (slower) rotational speed of the offset sheet-fed printing press is loaded from the memory M3 for the command rotational speed of the offset sheet-fed printing press. Then, in Step P30, the command (slower) rotational speed of the offset sheet-fed printing press and the virtual current position of the motor shaft of the rotary screen cylinder are transmitted to the drive control device 80 for the rotary screen cylinder. Then, in Step P31, the command (slower) rotational speed is outputted to the prime motor driver 67 for the offset sheet-fed printing press. Afterwards, the program returns to Step P19.

If the answer is NO in Step P22, it is determined in Step P32 whether a signal for completion of home position alignment of the motor shaft has been transmitted from the drive control device 80 for the rotary screen cylinder. If the answer is YES, the signal for completion of home position alignment of the motor shaft is received from the drive control device 80 for the rotary screen cylinder in Step P33. Then, in Step P34, the time interval for transmitting the command rotational speed of the offset sheet-fed printing press and the virtual current position of the rotary screen cylinder to the drive control device 80 for the rotary screen cylinder are loaded from the memory M5 for the time interval for transmitting the command rotational speed of the offset sheet-fed printing press and the virtual current position of the rotary screen cylinder to the drive control device for the rotary screen cylinder. In Step P35, the count value of the internal clock counter 61 is loaded.

Then, in Step P36, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, the set (slower) rotational speed is loaded from the memory M2 for the set rotational speed of the offset sheet-fed printing press in Step P37. Then, in Step P38, the set (slower) rotational speed is written into the memory M3 for the command rotational speed of the offset sheet-fed printing press. Afterwards, in Step P39, the count value is loaded from the counter 75 for detecting the motor shaft position of the offset sheet-fed printing press, and stored into the memory M6.

Then, in Step P40, the current position of the motor shaft of the offset sheet-fed printing press is computed from the count value of the counter 75 for detecting the motor shaft position of the offset sheet-fed printing press, and stored into the memory M7. Then, in Step P41, the correction value of the current position of the rotary screen cylinder is loaded from the memory M8 for the correction value of the current position of the rotary screen cylinder. Then, in Step P42, the loaded correction value of the current position of the rotary screen cylinder is added to the current position of the motor shaft of the offset sheet-fed printing press obtained by the above computation, whereby the virtual current position of the motor shaft of the rotary screen cylinder is computed and stored into the memory M9. Then, in Step P43, the command (slower) rotational speed of the offset sheet-fed printing press is loaded from the memory M3 for the command rotational speed of the offset sheet-fed printing press.

Then, in Step P44, the command (slower) rotational speed of the offset sheet-fed printing press and the virtual current position of the motor shaft of the rotary screen cylinder are transmitted to the drive control device 80 for the rotary screen cylinder. Then, in Step P45, the command (slower) rotational speed is outputted to the prime motor driver 67 for the offset sheet-fed printing press. Then, in Step P46, the command (slower) rotational speed of the offset sheet-fed printing press is written into the memory M10 for the previous command rotational speed of the offset sheet-fed printing press, whereafter the program shifts to Step P60.

If the answer is NO in Step P32, it is determined in Step P47 whether the stop signal for the printing press has been inputted. If the answer is NO, the program returns to Step P20. If the answer is YES, the time interval for transmitting the command rotational speed of the offset sheet-fed printing press and the virtual current position of the rotary screen cylinder to the drive control device 80 for the rotary screen cylinder are loaded in Step P48 from the memory M5 for the time interval for transmitting the command rotational speed of the offset sheet-fed printing press and the virtual current position of the rotary screen cylinder to the drive control device for the rotary screen cylinder. In Step P49, the count value of the internal clock counter 61 is loaded.

Then, in Step P50, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, the set (slower) rotational speed is loaded from the memory M2 for the set rotational speed of the offset sheet-fed printing press in Step P51. Then, in Step P52, the set (slower) rotational speed is written into the memory M3 for the command rotational speed of the offset sheet-fed printing press. Afterwards, in Step P53, the count value is loaded from the counter 75 for detecting the motor shaft position of the offset sheet-fed printing press, and stored into the memory M6.

Then, in Step P54, the current position of the motor shaft of the offset sheet-fed printing press is computed from the count value of the counter 75 for detecting the motor shaft position of the offset sheet-fed printing press, and stored into the memory M7. Then, in Step P55, the correction value of the current position of the rotary screen cylinder is loaded from the memory M8 for the correction value of the current position of the rotary screen cylinder. Then, in Step P56, the loaded correction value of the current position of the rotary screen cylinder is added to the current position of the motor shaft of the offset sheet-fed printing press obtained by the above computation, whereby the virtual current position of the motor shaft of the rotary screen cylinder is computed and stored into the memory M9. Then, in Step P57, the command (slower) rotational speed of the offset sheet-fed printing press is loaded from the memory M3 for the command rotational speed of the offset sheet-fed printing press.

Then, in Step P58, the command (slower) rotational speed of the offset sheet-fed printing press and the virtual current position of the motor shaft of the rotary screen cylinder are transmitted to the drive control device 80 for the rotary screen cylinder. Then, in Step P59, the command (slower) rotational speed is outputted to the prime motor driver 67 for the offset sheet-fed printing press. Then, the program shifts to Step P87 to be described later.

Then, in the aforementioned Step P60, counting of the internal clock counter (counting of the elapsed time) 61 is started. If, in the subsequent Step P61, the set rotational speed has been inputted to the rotational speed setting instrument 65, the set rotational speed is loaded from the rotational speed setting instrument 65, and stored into the memory M2, in Step P62. Then, in Step P63, the set rotational speed is loaded from the memory M2 for the set rotational speed of the offset sheet-fed printing press, whereafter the previous command rotational speed is loaded from M10 for the previous command rotational speed of the offset sheet-fed printing press in Step P64.

Then, in Step P65, it is determined whether the loaded set rotational speed of the offset sheet-fed printing press is equal to the loaded previous command rotational speed of the offset sheet-fed printing press. If the answer is YES, in Step P66 the loaded set rotational speed of the offset sheet-fed printing press is written into the memory M3 for the command rotational speed of the offset sheet-fed printing press. Then, the program shifts to Step P75.

If the answer is NO in the above Step P65, it is determined in Step P67 whether the loaded set rotational speed of the offset sheet-fed printing press is higher than the loaded previous command rotational speed of the offset sheet-fed printing press. If the answer is YES, the rotational speed modification value during speed increase is loaded in Step P68 from the memory M11 for the rotational speed modification value during speed increase. Then, in Step P69, the loaded rotational speed modification value during speed increase is added to the previous command rotational speed of the offset sheet-fed printing press, whereby the modified command rotational speed of the offset sheet-fed printing press is computed and stored into the memory M13. Then, in Step P70, the modified command rotational speed of the offset sheet-fed printing press obtained by computation is written into the memory M3 for the command rotational speed of the offset sheet-fed printing press. Then, the program shifts to Step P75.

If the answer is NO in the above Step P67, the rotational speed modification value during speed reduction is loaded in Step P71 from the memory M12 for the rotational speed modification value during speed reduction. Then, in Step P72, the loaded rotational speed modification value during speed reduction is subtracted from the previous command rotational speed of the offset sheet-fed printing press, whereby the modified command rotational speed of the offset sheet-fed printing press is computed and stored into the memory M13. Then, in Step P73, it is determined whether the modified command rotational speed of the offset sheet-fed printing press is less than 0. If the answer is YES, the modified command rotational speed of the offset sheet-fed printing press is rewritten as zero in Step P74. Then, the program shifts to the aforementioned Step P70. If the answer is NO, the program directly shifts to Step P70.

Then, in Step P75, the time interval for transmitting the command rotational speed of the offset sheet-fed printing press and the virtual current position of the rotary screen cylinder to the drive control device 80 for the rotary screen cylinder are loaded from the memory M5 for the time interval for transmitting the command rotational speed of the offset sheet-fed printing press and the virtual current position of the rotary screen cylinder to the drive control device for the rotary screen cylinder. In Step P76, the count value of the internal clock counter 61 is loaded.

Then, in Step P77, it is determined whether the count value of the internal clock counter 61 is equal to or greater than the time interval for transmitting the command rotational speed of the offset sheet-fed printing press and the virtual current position of the rotary screen cylinder to the drive control device 80 for the rotary screen cylinder. If the answer is YES, in Step P78 the count value is loaded from the counter 75 for detecting the motor shaft position of the offset sheet-fed printing press, and is stored into the memory M6. If the answer is NO, the program returns to Step P76. Then, in Step P79, the current position of the motor shaft of the offset sheet-fed printing press is computed from the count value of the counter 75 for detecting the motor shaft position of the offset sheet-fed printing press, and is stored into the memory M7. In Step P80, the correction value of the current position of the rotary screen cylinder is loaded from the memory M8 for the correction value of the current position of the rotary screen cylinder.

Then, in Step P81, the loaded correction value of the current position of the rotary screen cylinder is added to the current position of the motor shaft of the offset sheet-fed printing press obtained by computation, whereby the virtual current position of the motor shaft of the rotary screen cylinder is computed and stored into the memory M9. Then, in Step P82, the command rotational speed of the offset sheet-fed printing press is loaded from the memory M3 for the command rotational speed of the offset sheet-fed printing press. Then, in Step P83, the command rotational speed of the offset sheet-fed printing press and the virtual current position of the motor shaft of the rotary screen cylinder are transmitted to the drive control device 80 for the rotary screen cylinder. Subsequently, in Step P84, the command rotational speed is outputted to the prime motor driver 67 for the offset sheet-fed printing press.

Then, in Step P85, the command rotational speed of the offset sheet-fed printing press is written into the memory M10 for the previous command rotational speed of the offset sheet-fed printing press. Then, in Step P86, it is determined whether the stop switch for the printing press is ON. If the answer is YES, the program shifts to Step P87. If the answer is NO, the program returns to Step P60.

Then, in the aforementioned Step P87, zero is written into the memory M2 for the set rotational speed of the offset sheet-fed printing press. Then, in Step P88, counting of the internal clock counter (counting of the elapsed time) 61 is started, whereupon in Step P89 the previous command rotational speed is loaded from the memory M10 for the previous command rotational speed of the offset sheet-fed printing press. Then, in Step P90, it is determined whether the loaded previous command rotational speed of the offset sheet-fed printing press is zero. If the answer is YES, in Step P91 zero is written into the memory M3 for the command rotational speed of the offset sheet-fed printing press. Thereafter, the program shifts to Step P98 to be described later. If NO, in Step P92, the rotational speed modification value during speed reduction is loaded from the memory M12 for the rotational speed modification value during speed reduction.

Then, in Step P93, the loaded rotational speed modification value during speed reduction is subtracted from the previous command rotational speed of the offset sheet-fed printing press, whereby the modified command rotational speed of the offset sheet-fed printing press is computed and stored into the memory M13. Then, in Step P94, it is determined whether the modified command rotational speed of the offset sheet-fed printing press is less than 0. If the answer is YES, the modified command rotational speed of the offset sheet-fed printing press is rewritten as zero in Step P95. Then, in Step P96, the modified command rotational speed of the offset sheet-fed printing press obtained by computation is written into the memory M3 for the command rotational speed of the offset sheet-fed printing press. If the answer is NO, the program directly shifts to Step P96. Then, in Step P97, the modified command rotational speed obtained by computation is written into the memory M10 for the previous command rotational speed of the offset sheet-fed printing press.

Then, in the aforementioned Step P98, the time interval for transmitting the command rotational speed of the offset sheet-fed printing press and the virtual current position of the rotary screen cylinder to the drive control device 80 for the rotary screen cylinder are loaded from the memory MS for the time interval for transmitting the command rotational speed of the offset sheet-fed printing press and the virtual current position of the rotary screen cylinder to the drive control device for the rotary screen cylinder. In Step P99, the count value of the internal clock counter 61 is loaded. Then, in Step P100, it is determined whether the count value of the internal clock counter 61 is equal to or greater than the time interval for transmitting the command rotational speed of the offset sheet-fed printing press and the virtual current position of the rotary screen cylinder to the drive control device for the rotary screen cylinder. If the answer is YES, the count value is loaded in Step P101 from the counter 75 for detecting the motor shaft position of the offset sheet-fed printing press, and is stored into the memory M6. If the answer is NO, the program returns to Step P99.

Then, in Step P102, the current position of the motor shaft of the offset sheet-fed printing press is computed from the count value of the counter 75 for detecting the motor shaft position of the offset sheet-fed printing press, and is stored into the memory M7. Subsequently, in Step P103, the correction value of the current position of the rotary screen cylinder is loaded from the memory M8 for the correction value of the current position of the rotary screen cylinder. Then, in Step P104, the loaded correction value of the current position of the rotary screen cylinder is added to the current position of the motor shaft of the offset sheet-fed printing press obtained by computation, whereby the virtual current position of the motor shaft of the rotary screen cylinder is computed and stored into the memory M9. Then, in Step P105, the command rotational speed of the offset sheet-fed printing press is loaded from the memory M3 for the command rotational speed of the offset sheet-fed printing press.

Then, in Step P106, the command rotational speed of the offset sheet-fed printing press and the virtual current position of the motor shaft of the rotary screen cylinder are transmitted to the drive control device 80 for the rotary screen cylinder. Subsequently, in Step P107, the command rotational speed is outputted to the prime motor driver 67 for the offset sheet-fed printing press. Then, in Step P108, the outputs of the F/V converters 70 and 73 connected to the rotary encoder 71 for the prime motor for the offset sheet-fed printing press and the rotary encoder 74 for the drive motor for the rotary screen cylinder are loaded. Then, in Step P109, the current rotational speeds of the offset sheet-fed printing press and the rotary screen cylinder are computed from the loaded outputs of the F/V converters 70 and 73 connected to the rotary encoders 71 and 74 for the prime motor for the offset sheet-fed printing press and the drive motor for the rotary screen cylinder, and are stored into the memories M14 and M15, respectively.

Then, in Step P110, the rotational speed at which the synchronous operation of the rotary screen cylinder is stopped is loaded from the memory M16 for the rotational speed at which the synchronous operation of the rotary screen cylinder is stopped. Then, in Step P111, it is determined whether the current rotational speeds of the offset sheet-fed printing press and the rotary screen cylinder obtained by computation are equal to or less than the rotational speed at which the synchronous operation of the rotary screen cylinder is stopped. If the answer is YES, in Step P112 a synchronous operation stop command is transmitted to the drive control device 80 for the rotary screen cylinder. If the answer is NO, the programs returns to Step P88. Then, if in Step P113 a synchronous operation stop signal is transmitted from the drive control device 80 for the rotary screen cylinder, the synchronous operation stop signal is received from the drive control device 80 for the rotary screen cylinder in Step P114.

Then, in Step P115, the start signal for the prime motor driver 67 for the offset sheet-fed printing press is turned off, whereafter a work signal is outputted to the circuit 76 for the prime motor brake on the offset sheet-fed printing press in Step P116. Then, in Step P117, it is determined whether the synchronous operation switch is OFF. If the answer is YES, the program returns to Step P1. If the answer is NO, it is determined in Step P118 whether an offset sheet-fed printing press drive switch is ON. If the answer is YES, the program returns to Step P3. If the answer is NO, the program returns to Step P117. In accordance with the above-mentioned steps, the drive control device 50 for the offset sheet-fed printing press controls the prime motor 68 for the offset sheet-fed printing press and the drive motor 98 for the rotary screen cylinder to be operated in synchronization.

Then, in the aforementioned Step P119, it is determined whether the set rotational speed has been inputted into the rotational speed setting instrument 65. If the answer is YES, the set rotational speed is loaded from the rotational speed setting instrument 65, and stored into the memory M2, in Step P120. Then, the program shifts to Step P121. If the answer is NO, the program directly shifts to Step P122.

Then, in Step P121, it is determined whether the drive switch for the offset sheet-fed printing press is ON. If the answer is YES, in Step P122 a work release signal is outputted to the circuit 76 for the prime motor brake on the offset sheet-fed printing press. If the answer is NO, the program returns to Step PI. Then, in Step P123, a start signal for the prime motor driver 67 for the offset sheet-fed printing press is turned on, whereupon in Step P124 the set rotational speed of the offset sheet-fed printing press is written into the memory M3 for the command rotational speed of the offset sheet-fed printing press.

Then, in Step P125, the command rotational speed of the offset sheet-fed printing press is loaded from the memory M3 for the command rotational speed of the offset sheet-fed printing press. Then, in Step 126, the command rotational speed is outputted to the prime motor driver 67 for the offset sheet-fed printing press. Then, if the stop switch for the printing press is turned on in Step P127, a stop command is outputted to the prime motor driver 67 for the offset sheet-fed printing press in Step 128. Then, in Step P129, the start signal for the prime motor driver 67 for the offset sheet-fed printing press is turned off. Then, in Step P130, a work signal is outputted to the circuit 76 for the prime motor brake on the offset sheet-fed printing press, whereafter the program returns to Step P1. In accordance with the above-described steps, the drive control device 50 for the offset sheet-fed printing press controls the prime motor 68 for the offset sheet-fed printing press to be driven alone.

Next, the drive control device 80 for the rotary screen cylinder acts in accordance with the motion flows shown in FIGS. 21(a) and 21(b), FIGS. 22(a) and 22(b), and FIG. 23.

In Step P1, it is determined whether a home position alignment make-ready start command has been transmitted from the drive control device 50 for the offset sheet-fed printing press. If the answer is NO, the program shifts to Step P61 to be described later. If the answer is YES, in Step P2 the home position alignment make-ready start command is received from the drive control device 50 for the offset sheet-fed printing press. Then, in Step P3, a start signal for the drive motor driver 97 for the rotary screen cylinder is turned on. If in Step P4 a command (slower) rotational speed is transmitted from the drive control device 50 for the offset sheet-fed printing press, in Step P5 the command (slower) rotational speed is received from the drive control device 50 for the offset sheet-fed printing press, and stored into the memory M1.

Then, in Step P6, the command (slower) rotational speed of the offset sheet-fed printing press is loaded from the memory M1 for the command rotational speed of the offset sheet-fed printing press. Afterwards, in Step P7, the command (slower) rotational speed of the offset sheet-fed printing press is written into the memory M2 for the command rotational speed of the rotary screen cylinder. Then, in Step P8, the command rotational speed is outputted to the drive motor driver 97 for the rotary screen cylinder. If, in Step P9, a home position alignment ready command is transmitted from the drive control device 50 for the offset sheet-fed printing press, the home position alignment ready command is received from the drive control device 50 for the offset sheet-fed printing press in Step P10. Then, if in Step P11 a home position alignment start command is transmitted from the drive control device 50 for the offset sheet-fed printing press, the home position alignment start command is received from the drive control device 50 for the offset sheet-fed printing press in Step P12.

Then, if in Step P13 the command (slower) rotational speed of the offset sheet-fed printing press and the virtual current position of the motor shaft of the rotary screen cylinder are transmitted from the drive control device 50 for the offset sheet-fed printing press, the command (slower) rotational speed of the offset sheet-fed printing press and the virtual current position of the motor shaft of the rotary screen cylinder are received from the drive control device 50 for the offset sheet-fed printing press, and stored into the memory M1 and the memory M3, in Step P14. Then, in Step P15, the count value is loaded from the counter 101 for detecting the motor shaft position of the rotary screen cylinder, and stored into the memory M4. Subsequently, in Step P16, the current position of the motor shaft of the rotary screen cylinder is computed from the loaded count value of the counter 101 for detecting the motor shaft position of the rotary screen cylinder, and is stored into the memory M5.

Then, in Step P17, the difference in the current position of the motor shaft is computed from the above-mentioned received virtual current position of the motor shaft of the rotary screen cylinder and the computed current position of the motor shaft of the rotary screen cylinder, and stored into the memory M6. Subsequently, in Step P18, the absolute value of the difference in the current position of the motor shaft is computed from the above computed difference in the current position of the motor shaft, and stored into the memory M7. Then, in Step P19, the allowable value of the difference in the position of the motor shaft is loaded from the memory M8 for the allowable value of the difference in the position of the motor shaft. Upon its loading, it is determined in Step P20 whether the above-mentioned computed absolute value of the difference in the current position of the motor shaft is equal to or less than the allowable value of the difference in the position of the motor shaft.

If the answer is YES in Step P20, the command (slower) rotational speed of the offset sheet-fed printing press is loaded from the memory M1 for the command rotational speed of the offset sheet-fed printing press in Step P21. Upon its loading, the command (slower) rotational speed of the offset sheet-fed printing press is written into the memory M2 for the command rotational speed of the rotary screen cylinder in Step P22. Then, in Step P23, the command rotational speed is outputted to the drive motor driver 97 for the rotary screen cylinder. Then, in Step P24, a signal for completion of home position alignment of the motor shaft is transmitted to the drive control device 50 for the offset sheet-fed printing press. Then, the program shifts to Step P31 to be described later.

If the answer is NO in Step P20, the table for conversion between the difference in the current position of the motor shaft and the correction value of the command rotational speed (i.e., difference in current position of motor shaft-correction value of command rotational speed conversion table) is loaded in Step P25 from the memory M9 for the difference in current position of motor shaft-correction value of command rotational speed conversion table. Upon this loading, the difference in the current position of the motor shaft is loaded from the memory M6 for the difference in the current position of the motor shaft in Step P26. Then, in Step P27, the correction value of the command rotational speed of the rotary screen cylinder is obtained based on the difference in the current position of the motor shaft with the use of the difference in current position of motor shaft-correction value of command rotational speed conversion table, and is stored into the memory M10. Subsequently, in Step P28, the command (slower) rotational speed is loaded from the memory M1 for the command rotational speed of the offset sheet-fed printing press.

Then, in Step P29, the obtained correction value of the command rotational speed of the rotary screen cylinder is added to the loaded command (slower) rotational speed of the offset sheet-fed printing press, whereby the command rotational speed of the rotary screen cylinder is computed and stored into the memory M2. In Step P30, the command rotational speed is outputted to the drive motor driver 97 for the rotary screen cylinder. Then, the program returns to the aforementioned Step P13. In accordance with the above-described steps, the home position alignment of the drive motor 98 for the rotary screen cylinder with respect to the prime motor 68 for the offset sheet-fed printing press is carried out.

In the aforementioned Step P31, it is determined whether the command rotational speed of the offset sheet-fed printing press and the virtual current position of the motor shaft of the rotary screen cylinder have been transmitted from the drive control device 50 for the offset sheet-fed printing press. If the answer is NO, it is determined in Step P48 whether a synchronous operation stop command has been transmitted from the drive control device 50 for the offset sheet-fed printing press.

If the answer is YES in Step P31, the command rotational speed of the offset sheet-fed printing press and the virtual current position of the motor shaft of the rotary screen cylinder are received from the drive control device 50 for the offset sheet-fed printing press, and stored into the memory M1 and the memory M3, in Step P32. Then, in Step P33, the count value is loaded from the counter 101 for detecting the motor shaft position of the rotary screen cylinder, and stored into the memory M4. In Step P34, the current position of the motor shaft of the rotary screen cylinder is computed from the loaded count value of the counter 101 for detecting the motor shaft position of the rotary screen cylinder, and is stored into the memory M5.

Then, in Step P35, the difference in the current position of the motor shaft is computed from the above-mentioned received virtual current position of the motor shaft of the rotary screen cylinder and the computed current position of the motor shaft of the rotary screen cylinder, and stored into the memory M6. Subsequently, in Step P36, the absolute value of the difference in the current position of the motor shaft is computed from the above computed difference in the current position of the motor shaft, and stored into the memory M7. Then, in Step P37, the allowable value of the difference in the position of the motor shaft is loaded from the memory M8 for the allowable value of the difference in the position of the motor shaft. Upon its loading, it is determined in Step P38 whether the above-mentioned computed absolute value of the difference in the current position of the motor shaft is equal to or less than the loaded allowable value of the difference in the position of the motor shaft.

If the answer is YES in Step P38, the command rotational speed of the offset sheet-fed printing press is loaded from the memory M1 for the command rotational speed of the offset sheet-fed printing press in Step P39. Upon its loading, the command rotational speed of the offset sheet-fed printing press is written into the memory M2 for the command rotational speed of the rotary screen cylinder in Step P40. Then, in Step P41, the command rotational speed is outputted to the drive motor driver 97 for the rotary screen cylinder. Then, the program returns to Step P31.

If the answer is NO in Step P38, the difference in current position of motor shaft-correction value of command rotational speed conversion table is loaded in Step P42 from the memory M9 for the difference in current position of motor shaft-correction value of command rotational speed conversion table. Upon this loading, the difference in the current position of the motor shaft is loaded from the memory M6 for the difference in the current position of the motor shaft in Step P43. Then, in Step P44, the correction value of the command rotational speed of the rotary screen cylinder is obtained based on the difference in the current position of the motor shaft with the use of the difference in current position of motor shaft-correction value of command rotational speed conversion table, and is stored into the memory M10. Subsequently, in Step P45, the command rotational speed of the offset sheet-fed printing press is loaded from the memory M1 for the command rotational speed of the offset sheet-fed printing press.

Then, in Step P46, the obtained correction value of the command rotational speed of the rotary screen cylinder is added to the loaded command rotational speed of the offset sheet-fed printing press, whereby the command rotational speed of the rotary screen cylinder is computed and stored into the memory M2. In Step P47, the command rotational speed is outputted to the drive motor driver 97 for the rotary screen cylinder. Then, the program returns to Step P31.

If the answer is NO in Step P48, the program returns to Step P31. If the answer is YES in Step P48, on the other hand, a synchronous operation stop command is received from the drive control device 50 for the offset sheet-fed printing press in Step P49. Then, in Step P50, a synchronous operation stop signal is transmitted to the drive control device 50 for the offset sheet-fed printing press. Then, in Step P51, the slower rotational speed is loaded from the memory M11 for the slower rotational speed.

Then, in Step P52, the slower rotational speed is written into the memory M2 for the command rotational speed of the rotary screen cylinder, whereafter in Step P53 the command rotational speed is outputted to the drive motor driver 97 for the rotary screen cylinder. Then, in Step P54, the count value is loaded from the counter 101 for detecting the motor shaft position of the rotary screen cylinder, and stored into the memory M4. Then, in Step P55, the current position of the motor shaft is computed from the loaded count value of the counter 101 for detecting the motor shaft position of the rotary screen cylinder, and stored into the memory MS.

Then, in Step P56, the stop position of the rotary screen cylinder is loaded from the memory M12 for the stop position of the rotary screen cylinder. Then, in Step P57, it is determined whether the current position of the motor shaft equals the stop position of the rotary screen cylinder. If the answer is YES, a stop command is outputted to the drive motor driver 97 for the rotary screen cylinder in Step P58. If the answer is NO, the program returns to Step P54. Then, in Step P59, the start signal for the drive motor driver 97 for the rotary screen cylinder is turned off, whereupon a work signal is outputted to the circuit 78 for the drive motor brake on the rotary screen cylinder in Step P60. Then, the program returns to Step P1. In accordance with the above-described steps, the drive control device 80 for the rotary screen cylinder controls the drive motor 98 for the rotary screen cylinder to be synchronized with the prime motor 68 for the offset sheet-fed printing press, and controls the rotary screen cylinder to stop at a position where the hole-free portion A of the rotary screen 202 comes to the lower most position.

Then, in the aforementioned Step P61, it is determined whether the set rotational speed has been inputted to the rotational speed setting instrument 95 for the rotary screen cylinder. If the answer is YES, the set rotational speed is loaded from the rotational speed setting instrument 95 for the rotary screen cylinder, and stored into the memory M13, in Step P62. Then, the program shifts to Step P63. If the answer is NO, the program directly shifts to Step P63.

In Step P63, it is determined whether an individual drive switch for the rotary screen cylinder is ON. If the answer is YES, a work release signal is outputted to the circuit 78 for the drive motor brake on the rotary screen cylinder in Step P64. If the answer is NO, the program returns to Step P1. Then, in Step P65, a start signal for the drive motor driver 97 for the rotary screen cylinder is turned on, whereupon the set rotational speed of the rotary screen cylinder is written into the memory M2 for the command rotational speed of the rotary screen cylinder in Step P66.

Then, in Step P67, the command rotational speed of the rotary screen cylinder is loaded from the memory M2 for the command rotational speed of the rotary screen cylinder. Then, in Step P68, the command rotational speed is outputted to the drive motor driver 97 for the rotary screen cylinder. If the stop switch for the rotary screen cylinder is turned on in Step P69, the slower rotational speed is loaded from the memory M11 for the slower rotational speed in Step P70. Then, in Step P71, the slower rotational speed is written into the memory M2 for the command rotational speed of the rotary screen cylinder.

Then, in Step P72, the command rotational speed is outputted to the drive motor driver 97 for the rotary screen cylinder. Then, in Step P73, the count value is loaded from the counter 101 for detecting the motor shaft position of the rotary screen cylinder, and stored into the memory M4. Then, in Step P74, the current position of the motor shaft is computed from the loaded count value of the counter 101 for detecting the motor shaft position of the rotary screen cylinder, and stored into the memory M5. Then, in Step P75, the stop position of the rotary screen cylinder is loaded from the memory M12 for the stop position of the rotary screen cylinder.

Then, in Step P76, it is determined whether the current position of the motor shaft equals the stop position of the rotary screen cylinder. If the answer is YES, a stop command is outputted to the drive motor driver 97 for the rotary screen cylinder in Step P77. If the answer is NO, the program returns to Step P73. Then, in Step P78, the start signal for the drive motor driver 97 for the rotary screen cylinder is turned off, whereupon a work signal is outputted to the circuit 78 for the drive motor brake on the rotary screen cylinder in Step P79. Then, the program returns to Step P1. Subsequently, this procedure is repeated. In accordance with the above-described steps, the drive control device 80 for the rotary screen cylinder controls the drive motor 98 for the rotary screen cylinder to be individually driven, and controls the rotary screen cylinder to stop at the position where the hole-free portion A of the rotary screen 202 comes to the lowermost position.

According to the present embodiment, as described above, the drive control device 50 for the offset sheet-fed printing press and the drive control device 80 for the rotary screen cylinder start speed reduction of the rotational speed of the prime motor 68 under the stop command. When the rotational speed detected by the rotary encoder 71 becomes equal to or less than the predetermined rotational speed which is not zero, synchronous control of the drive motor 98 for the rotary screen cylinder is released. Then, the drive motor 98 for the rotary screen cylinder is controlled such that the rotary screen cylinder of the rotary screen device 200 is stopped at the position where the pattern-free portion (hole-free portion) A in the screen 202 comes to the lowermost position (see FIG. 5).

As noted above, the rotary screen cylinder is stopped at the position where the pattern-free portion (hole-free portion) A in the screen 202 comes to the lowermost position. Thus, ink does not fall from the pattern-free portion (hole-free portion) A.

Accordingly, the degree of freedom increases in the type of ink that can be used, and the size of the hole. The diversification of printing products can be achieved. At a standstill of printing, the rotary screen cylinder can also be stopped. Thus, the electric power consumption of the drive motor 98 for the rotary screen cylinder and the drive motor driver 97 for the rotary screen cylinder can be decreased, and the durability of the motor and the motor shaft bearing portion can be enhanced.

In the present embodiment, moreover, synchronous control is released when the rotational speed detected by the rotary encoder 71 becomes equal to or less than the predetermined rotational speed which is not zero. Thus, the advantage is obtained that the rotary screen cylinder of the rotary screen device 200 can be stopped at an earlier stage than in Embodiment 1.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A stop position control method of a rotary stencil printing press in which a stencil printing plate is held on a rotating body, and ink is transferred through holes of the stencil printing plate, with the rotating body being rotated, to carry out printing, comprising:
stopping the rotating body, in accordance with a stop signal, at a position at which a pattern-free portion of the stencil printing plate comes to a lowermost position.

2. The stop position control method of a rotary stencil printing press according to claim 1, wherein
the rotary stencil printing press is combined with a sheet-fed printing press employing other printing method, and
the pattern-free portion of the stencil printing plate is a portion corresponding to a sheet holding portion of the sheet-fed printing press employing other printing method where a sheet is held.

3. The stop position control method of a rotary stencil printing press according to claim 1, wherein
the rotary stencil printing press is combined with a sheet-fed printing press employing other printing method, and
the pattern free portion of the stencil printing plate is a portion corresponding to a plate holding portion of the sheet-fed printing press employing other printing method where a printing plate is held.

4. The stop position control method of a rotary stencil printing press according to claim 2 or 3, wherein
the rotary stencil printing press is equipped with a first motor for driving the sheet-fed printing press employing other printing method, and a second motor for driving the rotating body, and
the second motor is controlled to be synchronized with the first motor during printing.

5. The stop position control method of a rotary stencil printing press according to claim 4, wherein
the rotary stencil printing press is equipped with a first rotational speed detector for detecting a rotational speed of the first motor, and a second rotational speed detector for detecting a rotational speed of the second motor,
speed reduction of the rotational speed of the first motor is started under a stop command,
synchronous control of the second motor is released when the rotational speed detected by the first rotational speed detector becomes equal to or lower than a predetermined rotational speed, and
then the second motor is controlled to stop the rotating body at the position at which the pattern-free portion of the stencil printing plate comes to the lowermost position.

6. The stop position control method of a rotary stencil printing press according to claim 5, wherein the predetermined rotational speed is zero.

7. A stop position control apparatus of a rotary stencil printing press in which a stencil printing plate is held on a rotating body, and ink is transferred through holes of the stencil printing plate, with the rotating body being rotated, to carry out printing, comprising:
a controller for stopping the rotating body, in accordance with a stop signal, at a position at which a pattern-free portion of the stencil printing plate comes to a lowermost position.

8. The stop position control apparatus of a rotary stencil printing press according to claim 7, wherein
the rotary stencil printing press is combined with a sheet-fed printing press employing other printing method, and
the pattern free portion of the stencil printing plate is a portion corresponding to a sheet holding portion of the sheet-fed printing press employing other printing method where a sheet is held.

9. The stop position control apparatus of a rotary stencil printing press according to claim 7, wherein
the rotary stencil printing press is combined with a sheet-fed printing press employing other printing method, and
the pattern free portion of the stencil printing plate is a portion corresponding to a plate holding portion of the sheet-fed printing press employing other printing method where a printing plate is held.

10. The stop position control apparatus of a rotary stencil printing press according to claim 8 or 9, further comprising:
a first motor for driving the sheet-fed printing press employing other printing method; and
a second motor for driving the rotating body, wherein the controller controls the second motor to be synchronized with the first motor during printing.

11. The stop position control apparatus of a rotary stencil printing press according to claim 10, further comprising:
a first rotational speed detector for detecting a rotational speed of the first motor; and
a second rotational speed detector for detecting a rotational speed of the second motor,
wherein the controller
starts speed reduction of the rotational speed of the first motor under a stop command,
releases synchronous control of the second motor when the rotational speed detected by the first rotational speed detector becomes equal to or lower than a predetermined rotational speed, and
then controls the second motor to stop the rotating body at the position at which the pattern-free portion of the stencil printing plate comes to the lowermost position.

12. The stop position control apparatus of a rotary stencil printing press according to claim 11, wherein
the controller sets the predetermined rotational speed at zero.

13. The stop position control apparatus of a rotary stencil printing press according to claim 7, wherein
the stencil printing plate is a screen printing forme.
